(19) United States
(12) Patent Application Publication
(10) Pub. No.: US 2024/0135364 A1
(43) Pub. Date: Apr. 25, 2024

(54) METHOD FOR TRANSFERRING DATA OVER A BLOCKCHAIN NETWORK FOR DIGITAL TRANSACTIONS

(71) Applicant: BANCO DAVIVIENDA S.A., Bogotá (CO)

(72) Inventors: Charly AGUDELO, Mosquera (CO); Daniel Ricardo GÁLVAN, Bogotá (CO); Oscar Andrés LEÓN, Medellín (CO); Yesika PADILLA YAÑEZ, Bogotá (CO); Alejandro CLAVIJO SÁNCHEZ, Bogotá (CO)

(21) Appl. No.: 18/548,567

(22) PCT Filed: Jul. 6, 2022
(86) PCT No.: PCT/IB2022/056305

§ 371 Date: Aug. 30, 2023

(30) Foreign Application Priority Data
Jul. 6, 2021 (CO) NC2021/0008982

(51) Int. Cl. G06Q 20/36; G06Q 20/38; G06Q 20/40

(52) U.S. Cl. CPC G06Q 20/3674; G06Q 20/389; G06Q 20/4014

(57) ABSTRACT

The present disclosure relates to methods and systems for transferring data in a blockchain network. Specifically, the present disclosure relates to computer-implemented methods for creating and encrypting electronic wallets in blockchain networks and systems and methods configured to carry out data transactions in the blockchain network.

For example, the present disclosure describes a method for creating and encrypting an electronic wallet of a blockchain network, comprising a step of obtaining the electronic wallet by a computing device from a user. The electronic wallet may include a private password data, a public password data, and a wallet identification data. The method has steps wherein the private password data, the public password data and/or the wallet identification data are encrypted with random salt data. The encrypted data is transmitted via an API to computing modules having functions of data storage, processing of requests, and blockchain network access. Moreover, the method may include steps wherein the electronic wallet may be retrieved or restored, and steps in which the private password data can be decrypted to enable the use of transactional functions of the electronic wallet. Upon decrypting the encrypted private password, the computing device may store the private password data in a memory module, e.g., in a volatile memory module.

The present disclosure also describes method embodiments, including at least one process or method selected from a user identity verification process, a wallet recovery process, a wallet transaction access process, a token recovery method, a token transfer process, a token conversion process, and combinations thereof.

The present disclosure also describes system embodiments configured to carry out one or more of the method embodiments described in the present disclosure. The system may include a first computing module configured to manage an application that is configured to establish connection with a user computing device via a communications network, a second computing module configured to manage a database, wherein the second computing module is connected to the communications network. In addition, the system may include a third computing module connected to the first computing module, the second computing module, and the computing device via the communications network. In some embodiments, the system may further include an identification server connected to one or more of the computing modules and/or the computing device via the communications network. The system may further include a subnetwork establishing communication with an API managed by the second computing module. The subnetwork is configured to carry out a plurality of operational processes of a smart contract of the blockchain network. The subnetwork may comprise a plurality of interconnected nodes.

Moreover, the present disclosure also describes a computer program comprising instructions, which when the program runs on a system according to any of the above-described system embodiments, cause said system to carry out the steps of a method according to any of the method embodiments described in this disclosure. In addition, the present disclosure also describes a computer-readable medium comprising instructions, which when the program runs on a system according to any of the above-described embodiments, cause said system to carry out the steps of a method according to any of the method embodiments described in this disclosure.

### FIELD OF THE INVENTION

The present disclosure relates to methods and systems for transferring data in a blockchain network. Specifically, the present disclosure relates to computer-implemented methods for creating and encrypting electronic wallets in blockchain networks, and systems and methods configured to carry out data transactions in the blockchain network.

### DESCRIPTION OF THE PRIOR ART

The prior art discloses methods and systems for encrypting and recovering keys from electronic wallets of blockchain networks in U.S. Pat. No. 10,439,812 B2 and CN 109961276 A.

U.S. Pat. No. 10,439,812 B2 discloses a method and system for recovering private keys from distributed blockchain-based systems. The method has a step of providing an original private key associated with a storage location of a blockchain-based asset. This document mentions public/private key sets allowing a user to access the blockchain-based asset with the private key. Moreover, this document mentions that the blockchain-based asset has an address.

Furthermore, the method herein mentions a step of receiving supplemental recovery information provided by a user via a user computing device and has a step of deriving a first recovery seed from at least a subset of the supplemental recovery information, wherein the first recovery seed is non-invertible. Therefore, the first recovery seed cannot be reverse engineered to determine the private key.

It also discloses examples of supplemental recovery information, which include a user identifier, password, PIN code, passphrase, email address, answers to account recovery queries, etc. The first recovery seed (also known as a derivative) may be created using a function such as PBKDF2 or Argon2 or another one-way (non-invertible) function. At this step, a username and private key may be encrypted separately, e.g., using a cryptographic salt.

Also, the method disclosed herein has a step of storing, in a data storage entity, the original private key and the first recovery seed in connection with the supplemental recovery information, and a step of associating a recovery notification with a destination address that is not included in the subset of the supplemental recovery information used to generate the first recovery seed.

This document also discloses method embodiments in which a universal second factor authentication (U2F) device generates a public-private key pair and internally stores a U2F private key of the public-private key pair, in response to the detection of a connection between the user computing device and the U2F device. An example U2F device comprises a processor and/or memory and connects to auxiliary systems via USB, near-field communications, Bluetooth, or another suitable protocol.

Then, the method moves to a step of cryptographically protecting at least one of the original private keys and the first recovery seed using a U2F public key of the public-private key pair. Thus, up to this step the method has carried out two encryptions of the private key.

Moreover, this document discloses a step of deriving a second recovery seed (e.g., using an encryption method under AES, elliptic curve, among others) from at least a subset of the copy of the supplemental recovery information; and a step of obtaining a data set from the data storage entity, wherein the first recovery seed matches the second recovery seed.

Furthermore, this document mentions that the method may have a step of extracting the original private key from the dataset in response to detecting a connection between the user computing device and the U2F device, causing the U2F device to decrypt the original private key; and based on a decrypted original private key, it determines the storage location of the blockchain-based asset.

Said document mentions in several of its examples that the wallet can be accessed through the user's computing device, using a username and password, where both are encrypted with the private key under an asymmetric encryption scheme (e.g., elliptic curve and AES). The encrypted output (username and password) can be stored in a trusted third-party central database associated with the key recovery computer system, in a Blockchain transaction or on a device owned by the user, not limited to a phone or U2F device.

Furthermore, this document discloses that the encrypted key may be stored relationally to the user identifier, derived from the user identifier, or derived from the user identifier and passphrase together (derived means encrypted). If a third party stores the encrypted key on behalf of the user, access may be controlled to require two-factor authentication.

Additionally, this document mentions in its background description section a conventional custodial wallet using services to store and hide a user private key and cryptographically sign transactions on the user's behalf, but users do not have full control of their wallet accounts. In addition, this document indicates that the nature of the custodial wallet service makes the user's authentication information susceptible to security breaches. This may not be desirable if the user wishes to maintain complete control over their information, or if the custodial wallet provider were to suffer a cyber security breach.

In turn, CN 109961276 A discloses a digital currency transaction method that is applied to a digital currency wallet (a hardware element), and the digital currency wallet wirelessly communicates with the terminal. The wireless communication can be achieved via WI-FI, Bluetooth, NFC, RFID, etc.

The method may include a step of receiving a first transaction information sent by the terminal. The terminal may be an application terminal such as a cell phone, laptop, tablet, and POS machine. The transaction information may include user identity information, transaction time, transaction serial number, transaction terminal identity information, transaction wallet address information in digital currency, wallet name information in digital currency, payee address, payer address, transaction amount, etc.

Once the terminal is connected to the digital currency wallet, the user creates the original transaction information in the terminal. The terminal first encrypts the original transaction information to obtain the first transaction information, and then sends the first transaction information to the digital currency wallet to generate an electronic wallet. This document mentions encryption algorithms AES (Advanced Encryption Standard), DES (Data Encryption Standard, symmetric algorithm), 3DES (Triple DES, symmetric algorithm based on DES), IDEA (International Data Encryption Algorithm), and BLOWFISH algorithm.

This document mentions that the digital wallet decrypts and verifies the first transaction information to obtain the original transaction information, and then carries out a digital signature operation on the original transaction information according to mnemonic words (associated with the electronic wallet private key) and secret words to obtain the second transaction information.

Mnemonic words and secret words are stored in the digital currency wallet. The digital currency wallet may include an encryption module, such as an encryption chip that can store data information during digital signature operations. In the digital signature operation, the data information of a seed, a master private key, the public key and the address is required.

This document also mentions a step in which a second encryption is carried out on the second transaction information to obtain a third transaction information which is then sent to the terminal for said terminal to complete the digital currency transaction of the digital currency wallet according to the third transaction information.

Also, said document mentions that when the digital currency wallet is connected to the terminal for the first time, an initialization operation is required, in which an initialization directive is fetched to initiate the creation of mnemonic words from an entropy generator. The digital currency wallet uses the transaction password set by the user as the passphrase. The transaction passphrase may be in the form of numbers, letters, symbols, etc., or in the form of biometric information such as fingerprints and iris.

The private key is derived jointly through the mnemonic words and passphrase to then obtain the master private key. The digital currency wallet obtains the seed and master private key from the mnemonic phrase and passphrase according to the cryptographic algorithm and obtains the public key and address according to the master private key (BIP 44 standard).

From the above, in the method of this document a physical electronic wallet (hardware) is wirelessly connected to a user terminal (e.g., their Smartphone or PC). Moreover, this document discloses steps wherein the user's personal information is encrypted along with the private key of an electronic wallet account, among which a password, keyword (e.g., passphrase) may be included, wherein the encryption may be carried out based on algorithms under the AES standard.

Therefore, the prior art discloses methods and systems for creating and securing electronic wallets in blockchain networks using dedicated hardware elements to generate double authentication processes and use mnemonic word sequences to generate private and public keys of electronic wallets.

### BRIEF DESCRIPTION OF THE INVENTION

The present disclosure relates to methods and systems for transferring data in a blockchain network. Specifically, the present disclosure relates to computer-implemented methods for creating and encrypting electronic wallets in blockchain networks and systems, and methods configured to carry out data transactions in the blockchain network.

For example, the present disclosure describes a method for creating and encrypting an electronic wallet of a blockchain network, comprising a step of obtaining the electronic wallet by a user computing device. The electronic wallet may be obtained via a process under a BIP standard that may be carried out by the computing device. Moreover, the electronic wallet may comprise a private password data, a public pas sword data, and a wallet identification data.

The method may include a step of receiving in an application accessible by the computing device a first character string and a user password which are entered by the user, e.g., into the computing device. The application may be managed by a first computing module establishing connection with the computing device via a communications network.

Additionally, the method may include a step of obtaining a first encrypted seed through a first encryption process which may be carried out by the computing device, and which preferably takes as input the private password data, the public password data, the wallet identification data, the first character string and a first random salt.

The method may include a step of sending the first encrypted seed from the application to an application programming interface (API). The API may be managed by a third computing module that is connected to the first computing module and the computing device via the communication network. Moreover, the method may include a step of obtaining a second encrypted seed with the API by carrying out a second encryption process that may take as input the first encrypted seed and a second random salt.

Furthermore, the method may include a step of storing the encrypted second seed in an API access database. The database may be managed by a second computing module that is connected to the third computing module via the communications network.

The method may further include a step of obtaining an encrypted private password by a third encryption process carried out by the computing device that takes as input the user password and the private password data; and may have a step of storing the encrypted private password in a memory module of the computing device.

The computing device may be configured to decrypt the encrypted private password when a user enters the user password into the application. When decrypting the encrypted private password, the computing device may store the private password data in a memory module, e.g., in a volatile memory module.

The present disclosure also describes method embodiments including at least one process or method selected from a user identity verification process, a wallet recovery process, a wallet transaction access process, a token recovery method, a token transfer process, a token conversion process, and combinations of the foregoing.

The present disclosure also describes system embodiments configured to carry out one or more of the embodiments of the above-described methods.

The system may include a first computing module configured to manage an application that is configured to establish connection with a user computing device via a communications network, a second computing module configured to manage a database, wherein the second computing module is connected to the communications network. In addition, the system may include a third computing module connected to the first computing module, the second computing module, and the computing device via the communications network. In some embodiments, the system may further include an identification server that is connected to one or more of the computing modules and/or the computing device via the communications network. The system may further include a subnetwork that establishes communication with an API managed by the second computing module. The subnetwork is configured to carry out a plurality of operational processes of a smart contract of the blockchain network. The subnetwork may comprise a plurality of interconnected nodes.

Optionally, the system may have a central computing unit, which may contain the first computing module, the second computing module, and the third computing module.

In system embodiments without a central computing unit, or in which the central computing unit does not include all system modules, said system may comprise a plurality of modules, virtual cloud networks, virtual machines, servers, and computing units interconnected to each other by the communications network in which one or more communications protocols can be established. For example, such a system may include a virtual cloud network.

On the other hand, the present disclosure also describes a computer program comprising instructions, which when the program runs on a system according to any of the above-described system embodiments, cause said system to carry out the steps of a method according to any of the method embodiments previously described in this disclosure.

In addition, the present disclosure also describes a computer-readable medium comprising instructions, which when the program runs on a system according to any of the above-described embodiments, cause said system to carry out the steps of a method according to any of the method embodiments previously described in this disclosure.

### BRIEF DESCRIPTION OF THE DRAWINGS

FIG. 1 shows a block diagram of a method embodiment for creating and encrypting an electronic wallet of a blockchain network and a system embodiment configured to carry out said method embodiment, wherein the block diagram depicts data and processes obtained and carried out between steps A) to F) of said method embodiment.

FIG. 2 shows a continuation of the block diagram of FIG. 1, wherein the block diagram depicts data and processes obtained and carried out between steps G) and H) of said method embodiment.

FIG. 3 shows a flow diagram of the method embodiment depicted in FIG. 1 and FIG. 2.

FIG. 4 shows a block diagram of an embodiment of a wallet transaction access process depicting when an encrypted private key is decrypted by entering a user password, wherein the private key is stored in a volatile memory module.

FIG. 5 shows a block diagram of an embodiment of a user identity verification process.

FIG. 6 shows a block diagram of an embodiment of an electronic wallet recovery process of a blockchain network, wherein the block diagram depicts data and processes obtained and carried out between steps i) and x) of said embodiment of the electronic wallet recovery process.

FIG. 7 shows a block diagram of a method embodiment for retrieving tokens from an electronic wallet for a blockchain network, wherein the block diagram depicts data and processes obtained and carried out between steps J) to T) of said embodiment of the token-retrieving method.

FIG. 8 shows a block diagram of an embodiment of a token transfer process of an electronic wallet for a blockchain network, wherein the block diagram depicts data and processes obtained and carried out between steps R) to Y) of said embodiment of the token transfer process.

FIG. 9 shows a block diagram of an embodiment of a token conversion process of an electronic wallet for a blockchain network, wherein the block diagram depicts data and processes obtained and carried out between steps Z1) to Z9) of said embodiment of the token transfer process.

FIG. 10 shows a block diagram of a system embodiment configured to carry out any of the method embodiments disclosed herein, wherein the system includes a first computing module, a second computing module, and a third computing module located in a central computing unit.

FIG. 11 shows a block diagram of an embodiment of the system of FIG. 10, which identifies an API managed by the third computing module connecting to a subnetwork of a blockchain network and to an identification server.

FIG. 12 shows a block diagram of a system embodiment configured to carry out any of the method embodiments disclosed herein, wherein the system includes a first computing module, a second computing module, and a third computing module, spatially located at different locations.

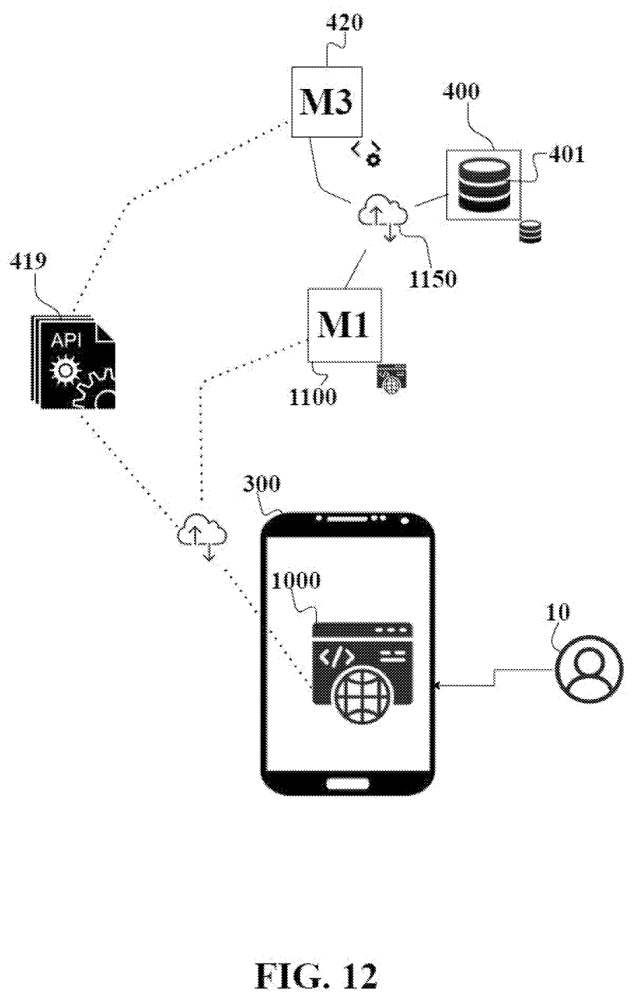

FIG. 13 shows a block diagram of a system embodiment and a process of transferring tokens of an electronic wallet for a blockchain network, wherein the block diagram depicts data and processes obtained and carried out between steps R) to Y) of said embodiment of the token transfer process. This figure depicts how a computing device receives an identification code, which in this case is depicted as a QR code.

FIG. 14 shows a block diagram of a system embodiment having a virtual network in the cloud.

### DETAILED DESCRIPTION

The present disclosure relates to methods and systems for transferring data in a blockchain network. Specifically, the present disclosure relates to computer-implemented methods for creating and encrypting electronic wallets in blockchain networks and systems and methods configured to carry out data transactions in the blockchain network.

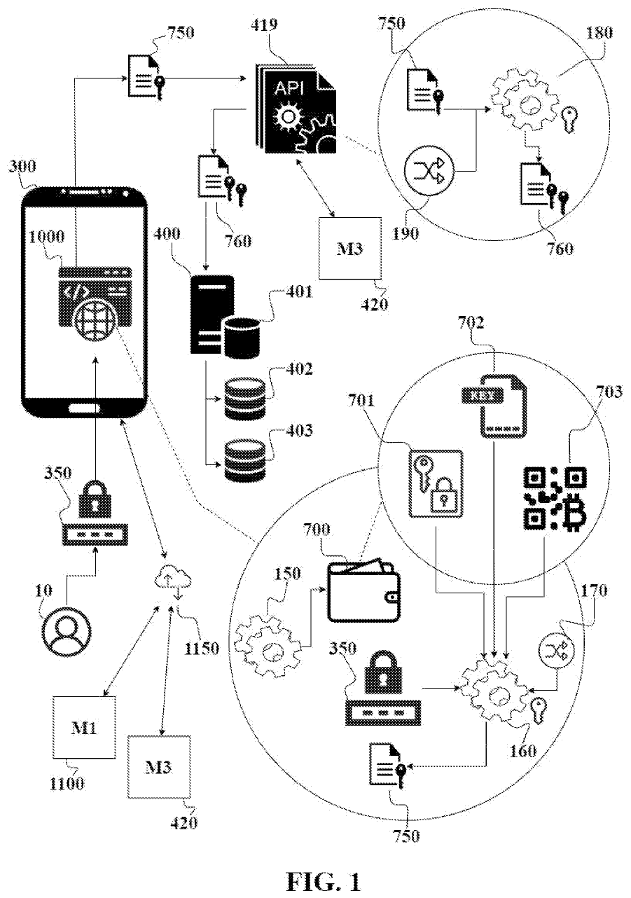

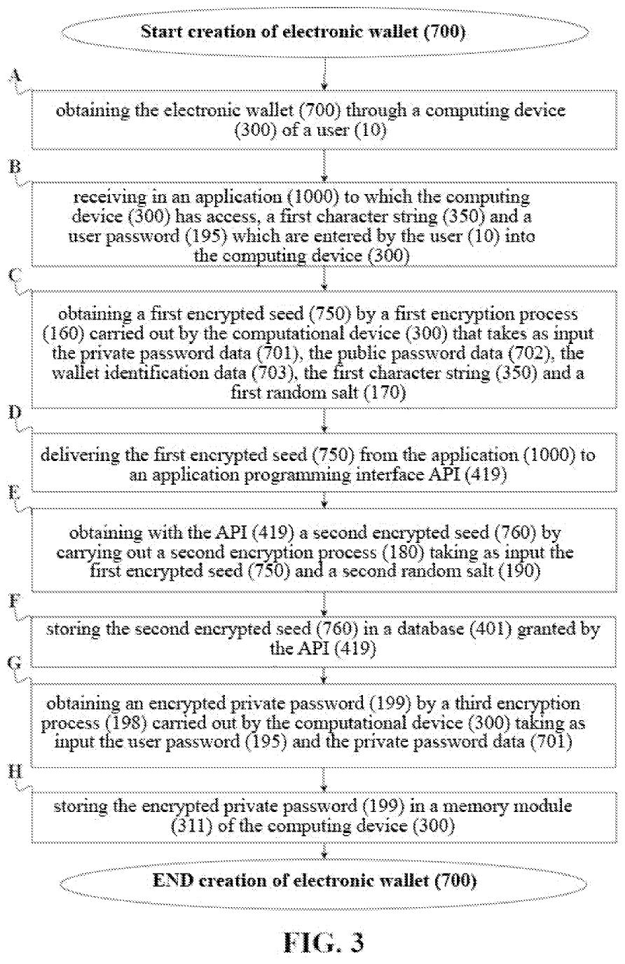

For example, referring to FIG. 1 and FIG. 3 in the present disclosure a method for creating and encrypting an electronic wallet (700) of a blockchain network (2000) is described, comprising a step A) of obtaining the electronic wallet (700) by a computing device (300) from a user (10). The electronic wallet (700) may be obtained through a process under BIP standard (150) that may be carried out by the computing device (300). Moreover, the electronic wallet (700) may include a private password data (701), a public password data (702), and a wallet identification data (703).

The method may include a step B) of receiving in an application (1000) accessible by the computing device (300) a first character string (350) and a user password (195) that are entered by the user (10), e.g., into the computing device (300). The application (1000) is managed by a first computing module (1100) which establishes connection with the computing device (300) via a communications network (1150).

The method may include a step C) of obtaining a first encrypted seed (750) through a first encryption process (160) that may be carried out by the computing device (300) and that may take as input the private password data (701), the public password data (702), the wallet identification data (703), the first character string (350), and a first random salt (170).

The method may include a step D) of sending the first encrypted seed (750) from the application (1000) to an application programming interface API (419). The API (419) may be managed by a third computing module (420) connected to the first computing module (1100) and the computing device (300) via the communications network (1150).

Referring to FIG. 1 and FIG. 3, the method may include a step E) of obtaining a second encrypted seed (760) with the API (419) by carrying out a second encryption process (180) that may take as input the first encrypted seed (750) and a second random salt (190). Moreover, the method may include a step F) of storing the second encrypted seed (760) in a database (401) accessed by the API (419). The database (401) may be managed by a second computing module (400) connected to the third computing module (420) via the communications network (1150).

The method may include a step G) of obtaining an encrypted private password (199) by a third encryption process (198) carried out by the computing device (300) taking as input the user password (195) and the private password data (701); and may have a step H) of storing the encrypted private password (199) in a memory module (311) of the computing device (300).

The computing device (300) may be configured to decrypt the encrypted private password (199) when a user enters into the application (1000) the user password (195). When decrypting the encrypted private password (199) the computing device (300) may store in a memory module, e.g., in a volatile memory module (310) the private password data (701).

The method embodiments having steps A) to H) allow creating an electronic wallet (700) in which the user (10) does not need to remember several mnemonic words as in the case of electronic wallets for traditional blockchain networks (hereinafter referred to as traditional wallets). In such traditional wallets they require the user (10) to memorize or remember up to 12 words mnemonics in order to register the traditional wallet on a computing device (300). Occasionally, the user (10) may lose the mnemonic words and in that scenario, would lose the traditional wallet with all of its information contained therein, among which may be cryptocurrencies representing considerable monetary value.

Now, the method embodiments having steps A) to H) allow maintaining the characteristic security of blockchain networks, however, they facilitate the user the registration of the electronic wallet (700) in computing devices (300), since in this case a first string of characters (350) and a user password (195) that are entered by the user (10) are managed. Moreover, the method allows having encryption processes (160, 180) encrypting the characteristic data of the electronic wallet (700) (e.g., the private password data (701), the public password data (702), the wallet identification data (703)) so that only the user (10) has access to the “keys” that allow decrypting said characteristic data of the electronic wallet (700).

Particularly, the method in step C) allows obtaining a first encrypted seed (750) through a first encryption process (160) taking as input the private password data (701), the public password data (702), the wallet identification data (703), the first character string (350), and a first random salt (170). The first encryption process (160) takes a random data, in this case, the random salt (170), and the first character string (350), which is known to the user (10), and preferably is not stored in any database or memory record. In this case, it is worth emphasizing that the user (10) memorizes a piece of data, e.g., a word or sequence of alphanumeric characters, instead of 12 mnemonic words as in the case of traditional wallets.

In order to facilitate the recovery of the electronic wallet (700), e.g., in case the user (10) changes the computing device (300), the first encrypted seed (750) is encrypted again in steps D) and E) of the method, obtaining the second encrypted seed (760), which is stored in a database (401) managed by a second computing module (400).

In the event that the second computing module (400) suffers a computer attack and a hacker has access to the second encrypted seed (760), this data would not allow them to obtain alone by themselves the characteristic data of the electronic wallet (700), since they would have to overcome the barrier of decrypting the second encrypted seed (760) to obtain the first encrypted seed (750), and then, they must decrypt the first encrypted seed (750) and “guess” or derive the first character string (350), which, as stated above, is preferably not stored in a memory or database record that the hacker could reach. For example, if the user (10) has the first character string (350) memorized, or has it written down on paper, the hacker would not be able to access it.

In step D) the application (1000) sends the first encrypted seed (750) to the API (419) managed by a third computing module (420). The API (419) obtains the second encrypted seed (760) when it carries out in step E) a second encryption process (180) taking as input the first encrypted seed (750) and a second random salt (190). Now, after having encrypted the characteristic data of the electronic wallet (700) twice, the second encrypted seed (760) is sent to the second computing module (400) so that in step F), it stores said second encrypted seed (760) in a database (401).

In steps G) and H) the method has third encryption process (198) carried out by the computing device (300). One of the advantages of the third encryption process (198) is to facilitate the user (10) to sign outgoing data transactions from their electronic wallet (700) by remembering only a user password (195), instead of having to remember more complex character strings as is the case with the private password data (701) of traditional wallets.

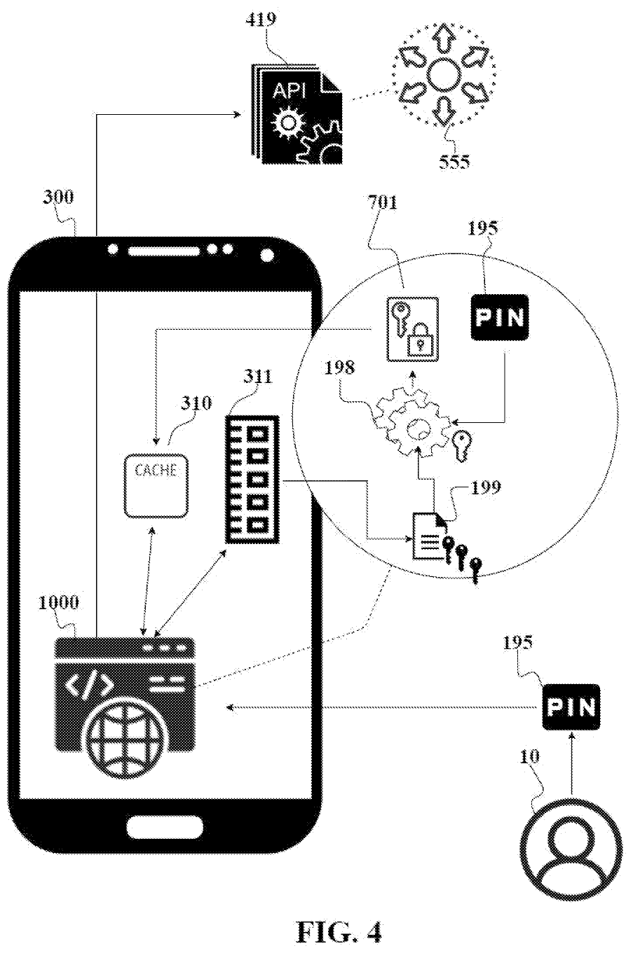

Referring to FIG. 4, in method embodiments having steps G) and H), the user (10) may choose as a user password (195) a numeric data, e.g., a four-digit number, a dot pattern, a short keyword, or a short character sequence (e.g., 6 characters or less). Such a user password (195) is preferably not stored in a memory or database record that can be accessed by the first computing module (1100), the second computing module (400), or the third computing module (420). In this case, the third encryption process (180) may be carried out directly on the computing device (300) and may even be carried out without the computing device (300) being connected to the communications network (1150) (e.g., Internet, WAN, LAN).

In order to enhance the security of the electronic wallet (700), the computing device (300) is configured to decrypt the encrypted private password (199) when a user enters into the application (1000) the user password (195), wherein upon decryption of the encrypted private password (199) the computing device (300) stores in a volatile memory module (310) the private password data (701). Accordingly, if the user restarts the computing device (300), or if the computing device (300) refreshes its volatile memory (310) (e.g., cache memory) periodically, or in response to the interaction of the user (10) with said computing device (300), the private password data (701) is removed from the volatile memory (310) thereby preventing the private password data (701) from being “stolen,” e.g., by a computer attack on the computing device (300).

According to the above, the method embodiments having steps A) to H) make it possible to improve the security of the electronic wallet (700) and at the same time, make it easier for the user (10) how to sign outgoing transactions of the electronic wallet (700) and make it easier for the user (10) to install or register the electronic wallet (700) on a computing device (300) as compared to traditional wallets.

Also, these method embodiments allow maintaining the characteristic advantages of traditional blockchain network wallets, e.g., security of data transactions, and confidentiality, since although the second encrypted seed (760) is stored in the database (401), based on said second encrypted seed (760) it is not possible to access the functions proper to the electronic wallet (700), e.g., information related to cryptocurrency transactions, tokens, or similar information.

In the present disclosure, installing an electronic wallet (700) in a computing device (300) is defined as an action, process or method comprising steps and/or steps wherein the computing device (300) stores in a memory record (e.g., of the memory module (311)) at least one data of the electronic wallet (700) (e.g., the public password data (702), the wallet identification data (703)) enabling the computing device (300) to access functions of the electronic wallet (700) (e.g., data modification, data transfer functions, data management functions within the electronic wallet (700)). For example, installing an electronic wallet (700) on a computing device (300) may include a step of installing the application (1000) on the computing device (300) and carrying out step A) on the computing device (300) to locally create the electronic wallet (700).

In the present disclosure, registering an electronic wallet (700) in a computing device (300) is defined as an action, process, or method that includes steps wherein the computing device (300) accesses the application (1000), wherein, the user (10) preferably authenticates as a valid user, and includes steps wherein the computing device (300) may download from interactions with the application (1000) a data that enables the computing device (300) to access the electronic wallet (700). For example, registering an electronic wallet (700) to a computing device (300) may include receiving at the computing device (300) the first encrypted seed (750) and reversing the first encryption process (160) when the user (10) enters the first character string (350) to decrypt the electronic wallet (700). In this case, it is not necessary that the computing device (300) receiving the first encrypted seed (750) was the same computing device (300) on which the electronic wallet (700) was created.

In any embodiment of the method comprising steps A) to H), the first encryption process (160), the second encryption process (180) and the third encryption process (198) are selected from AES, AES 256, AES 132, Blowfish, DES, Serpent, Twofish processes and combinations thereof.

In case of using combinations of such processes, this combination can be carried out in series, i.e., carrying out first one encryption process (e.g., AES 132) and then another encryption process (e.g., TwoFish).

In an example of a method including steps A) to H), the first encryption process (160), the second encryption process (180) and the third encryption process (198) are selected between AES 132 and AES 136 processes. One of the advantages of these encryption processes is their speed and the use of fewer resources and requirements for both hardware and storage compared to other traditional encryption processes. Additionally, any alteration to the message or encryption key results in a completely different ciphertext. These encryption algorithms have a variable key length, which allows them to be parameterized as needed, so the task of decrypting AES by verifying each of the possible key values (a “brute force” attack) is computationally intensive, making the data difficult, and eventually impossible, to decrypt.

In any embodiment of the method comprising steps A) to H), the method may further comprise a step AA) preceding step A) of carrying out a user identity verification process.

The user identity verification process allows providing an additional layer of security to the electronic wallet (700) in which the user (10) must prove their identity.

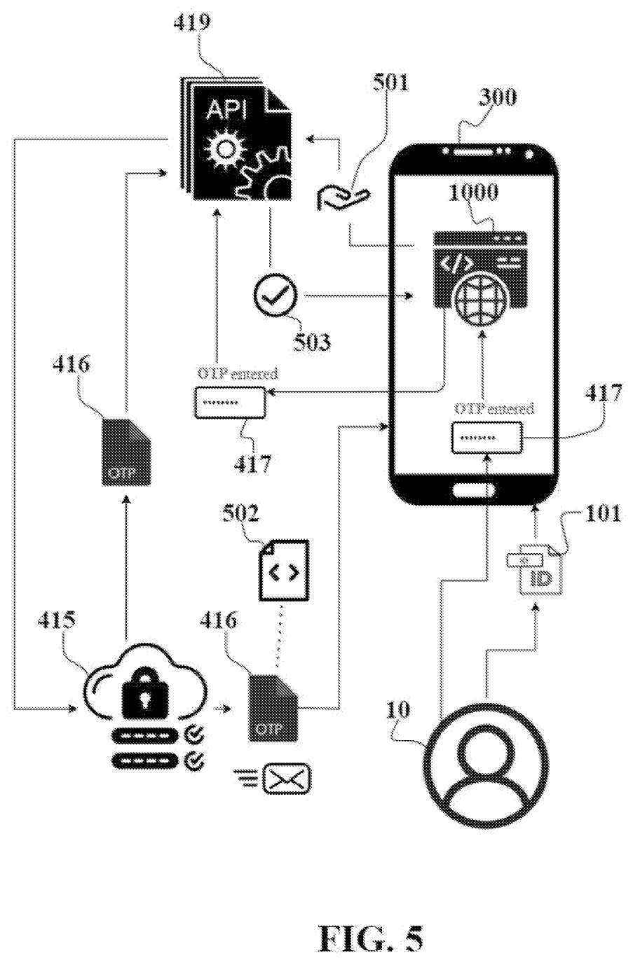

For example, the user identity verification process may be a One Time Password (OTP) authentication process. In this case, referring to FIG. 5, the user identity verification process may include a substep AA1) of receiving at the application (1000) a user identification data (101) entered by the user (10) into the computing device (300); and a substep AA2) of sending from the application (1000) an OTP request (501) to the API (419), wherein the OTP request (501) includes the user identification data (101) of the user (10).

Moreover, the user identity verification process may include a substep AA3) of obtaining via an identification server (415) an identification data (416) including an OTP key data (502) after the API (419) receives the OTP request (501); and a substep AA4) of sending via the identification server (415) the identification data (416) to a user address. The user address may be selected from a telephone number, email address, social network profile address, and combinations thereof.

Also, the user identity verification process may include a substep AA5) of obtaining in the application (1000) an OTP input data (417) that may be entered by the user via the computing device (300) after receiving the identification data (416); and a substep AA6) of sending from the application (1000) to the API (419) the OTP input data (417). Alternatively, when the computing device (300) has access to the user address, the computing device (300) may be configured to enter the OTP input data (417) automatically. For example, the computing device (300) may receive the identification data (416) in an e-mail, push message, or SMS message, and automatically extract the OTP input data (417) and enter it into the application (1000).

The user identity verification process may further have a substep AA7) of obtaining via API (419) an OTP validation data (503) when the OTP input data (417) matches the OTP key data (502) and proceed to step A), otherwise repeat substep AA1).

The user identity verification process may include additional identity validations, e.g., validation processes that take as input patterns, biometric data, such as, images of the user (e.g., facial recognition), fingerprints, voice commands (e.g., voice recognition), input data from accelerometers and gyroscopes (e.g., gait recognition), and any other user identity verification process that is known to a person moderately skilled in the art.

Moreover, the identification server (415) may carry out a counting process that increases a counter by one unit each time the steps of generating the OTP key data and comparing the same with the OTP input data (417) are carried out. When the counter reaches a predetermined value, the process is terminated, and an error message is displayed on the computing device (300).

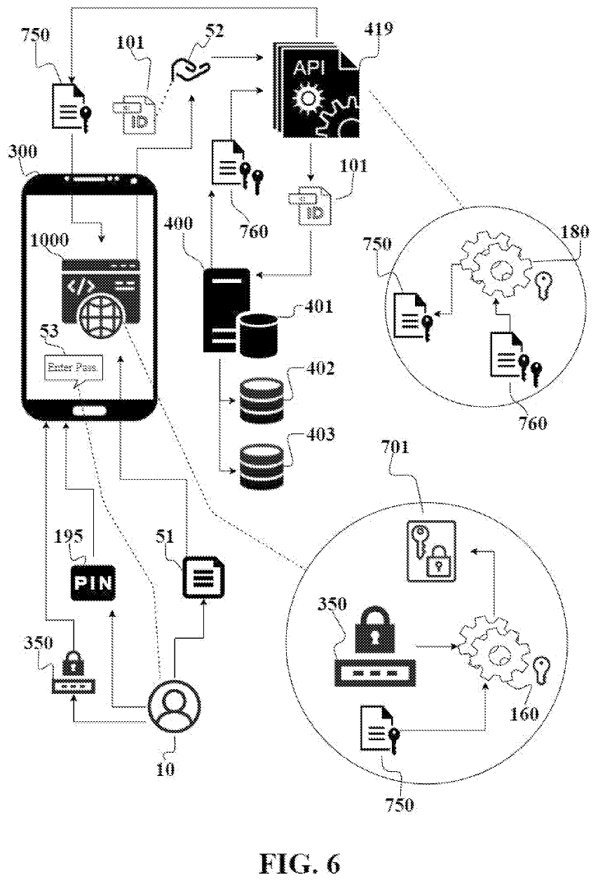

On the other hand, referring to FIG. 6, the present disclosure also describes a wallet recovery process by which the electronic wallet (700) may be retrieved. The wallet recovery process may include a step i) of receiving at the application (1000) a wallet recovery command (51) that may be entered by the user (10) via the computing device (300) and a step ii) of sending a wallet recovery request (52) from the application (1000) to the API (419), wherein the wallet recovery request (52) may include a user identification data (101).

The wallet recovery process may further include a step iii) of extracting the second encrypted seed (760) from the database (401) via the API (419), wherein the API (419) may query the database (401) taking as input a data, e.g., the user identification data (101). The wallet recovery process may further include a step iv) of obtaining the first encrypted seed (750) at the API (419) by decrypting the second encrypted seed (760) and may include a step v) of receiving at the application (1000) the first encrypted seed (750), e.g., from the API (419).

The wallet recovery process may also have a step vi) of displaying in the application (1000) a character string input message (53); and a step vii) of receiving in the application (1000) the first character string (350), e.g., when the user (10) enters said first character string (350) into the computing device (300).

The wallet recovery process may further include a step viii) of decrypting at the computing device (300) the first encrypted seed (750) to obtain the private password data (701); and a step ix) of receiving at the computing device (300) a user password (195) entered by the user (10).

Upon completion of step ix) the wallet recovery process may carry out the carry out steps G) to H) of the method for creating and encrypting an electronic wallet (700) of a blockchain network (2000) which were previously described.

Accordingly, the wallet recovery process comprising steps i) to ix) enables a user (10) to retrieve an electronic wallet (700), e.g., to register it or install it on a computing device (300) for the first time, or after the computing device (300) has been formatted, altered, or modified, e.g., after the application (1000) and/or the electronic wallet (700) has been deleted in the computing device (300).

The present disclosure also describes a wallet transaction access process. Referring to FIG. 4, the wallet transaction access process may include a step I) of receiving at the application (1000) the user password (195) entered by the user (10) into the computing device (300); and a step II) of decrypting with computing device (300) the encrypted private password (199), wherein the computing device (300) stores the private password data (701) in a volatile memory module (310). The wallet transaction access process may also have a step III) of establishing communication between the application (1000) and a blockchain transaction module (555) of the API (419). Upon completion of step III) the electronic wallet (700) is enabled to make transactions on the blockchain network (2000) through interaction of the user (10) with the application (1000) via the computing device (300).

As mentioned above, one of the advantages of the method disclosed herein having as input of one or more of its steps or processes the user password (195) is to facilitate the user (10) to access their electronic wallet (700), e.g., when they want to transfer tokens, cryptocurrencies or any other type of data contained in the electronic wallet (700) and exchanged on the blockchain network (2000). In turn, this improves the computing performance of the computing device (300) as it requires fewer user interactions (10) compared to the case where it would have to enter long character strings, e.g., series of mnemonic words. In addition, one of the advantages of having the user password (195) is to prevent the private password data (701) from being stored in a long-term memory of the computing device (300) (e.g., the memory module (311)) that may be exposed to computer attacks.

Additionally, the wallet transaction access process may include additional steps and processes, e.g., it may include an identity verification process such as One Time Password (OTP) authentication processes, validation processes that take as input patterns, biometric data, such as, user's images (e.g., facial recognition, fingerprints, voice commands (e.g., voice recognition), input data from accelerometers and gyroscopes (e.g., gait recognition), and any other validation processes that take as input data from accelerometers and gyroscopes (e.g., gait recognition), facial recognition), fingerprints, voice commands (e.g., voice recognition), input data from accelerometers and gyroscopes (e.g., gait recognition) and any other user identity verification process that is known to a person moderately knowledgeable in the field.

Moreover, the application (1000) may include a user authentication module employing a user/password scheme.

These user authentication processes, and user authentication modules provide layers of security to the electronic wallet (700) that increase the time required to hack the various user authentication processes, encryption processes (160, 180, 198) and finally be able to access the electronic wallet (700).

On the other hand, the present disclosure also describes a token recovery method (556) enabling a user (10) who has forgotten the first character string (350) to retrieve data stored in the electronic wallet (700). The token recovery method (556) may be part of any of the method embodiments disclosed herein.

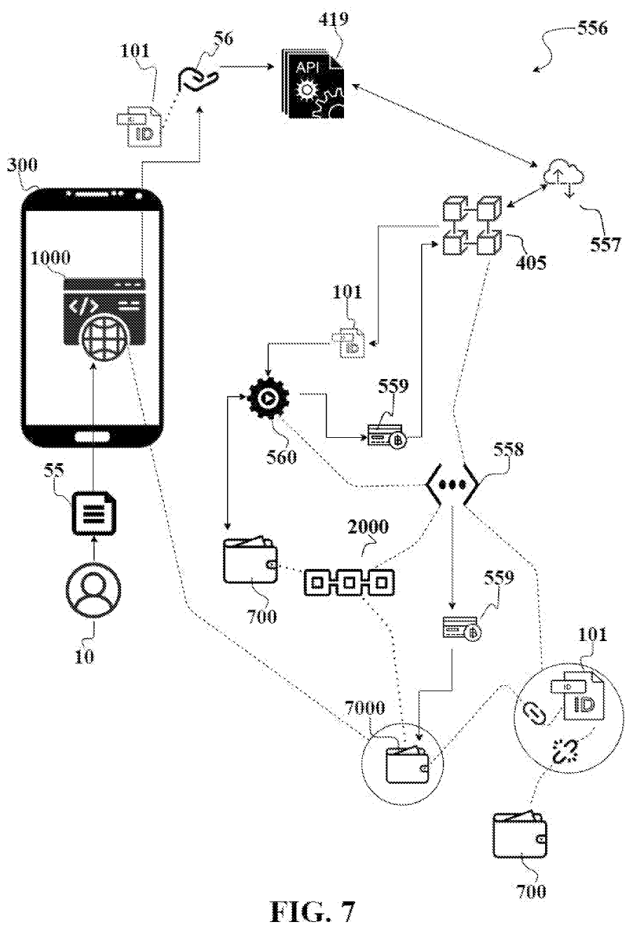

For example, referring to FIG. 7, the token recovery method (556) may include a J) step of receiving at the application (1000) an account recovery command (55) entered by the user (10) into the computing device (10) and a K) step of sending an account recovery request (56) from the application (1000) to the API (419); wherein the account recovery request (56) includes a user identification data (101) of the user (10).

After step K) a step L) of repeating steps A) to H) is carried out to obtain a second electronic wallet (7000). Accordingly, the second electronic wallet (7000) is generated through a process under BIP standard (150) carried out by the computing device (300), and said second electronic wallet (7000) has a private password data (701), a public password data (702) and a wallet identification data (703), which are different from the private password data (701), public password data (702) and wallet identification data (703) of the electronic wallet (700) from which tokens are to be retrieved.

Similarly, in step L) steps B) to H) are carried out in the same manner as explained above for the described method embodiments for creating and encrypting an electronic wallet (700) of a blockchain network (2000), only that in this opportunity the data related to the second electronic wallet (7000) is taken as input. Now, it shall be understood that the user password (195) and the first string of characters (350) will be different from those that the user (10) had previously entered in step B) of the method for creating and encrypting the electronic wallet (700), since it is likely that said user enters the recover account command (55) because they forgot the user password (195) and the first string of characters (350) that allowed them to recover the electronic wallet (700) as such.

After step L) ends, one has a second electronic wallet (7000) preferably empty, i.e., without tokens or cryptographic data (e.g., cryptocurrencies). At this point, the method carries out a step M) of establishing connection between the API (419) and the blockchain network (2000) through a communications protocol (557) that allows connecting with a subnetwork (405) configured to carry out some operational processes (558) of the smart contract of the blockchain network (2000).

In any of the method embodiments described in the present disclosure, the blockchain network (2000) may have associated with it a smart contract that may include a plurality of rules, data structures, and operational processes (558) that enable transferring, receiving, querying, and associating data such as tokens, cryptocurrencies, text data, statement data, transaction history data, ledger data, and other data that may be created, modified, transferred, and manipulated within a blockchain network (2000).

Examples of such blockchain networks (2000) are Ethereum, and RootStock (RSK). The smart contract may be a computer-implemented method with rules and conditionals, referred to in the present disclosure as operational processes (558) which determine when a data transaction may be carried out between one or more electronic wallets (700, 7000) of the blockchain network (2000), or determine whether a terminal, user, computing device, or server is authorized to access the blockchain network (2000). Similarly, the smart contract may include one or more operational processes (558) configured to record and verify data transactions on the blockchain network (2000) and generate a distributed transaction ledger that is stored on a plurality of nodes (406, 407, 408, 409) of the subnetwork (405).

Also, the smart contract may include one or more operational processes (558) that allow communicating the blockchain network (2000) with computing devices, servers, terminals, and other hardware elements or virtual machines configured to carry out processes and/or manage applications, APIs and similar elements that require exchanging, extracting, or supplying data to the blockchain network (2000). In an example of the blockchain network smart contract (2000) this works with proxy contracts to enhance interface update features, storage, logic, and implements role control (e.g., Owner, Administrator, Minter, Burner, Batch role of txs). Also, proxy contracts can have modules for Transfers, Issuance Control, Whitelist, among others.

Referring to FIG. 7, resuming the embodiment of the token recovery method (556) that had been described above, said token recovery method (556) may include a step N) of obtaining with the subnetwork (405) a balance data (559) of the electronic wallet (700) by a query process (560) taking as input the user identification data (101); wherein query process (560) is one of the operating processes (558).

Optionally, the query process (560) is configured to access the balance data (559), and not access other data of the electronic wallet (700) such as the private password data (701), the public password data (702), and the wallet identification data (703). Also, the query process (560) may include one or more rules in which access to an incoming and/or outgoing data transaction ledger associated with the electronic wallet (700) is prevented. In this way, the query process (560) allows retrieving data contained in the electronic wallet (700) having, e.g., a monetary value (e.g., tokens, digital contracts). However, privacy and security of the electronic wallet (700) which usually characterize traditional blockchain networks (e.g., Ethereum, RSK) are maintained.

The token recovery method (556) may further comprise an O) step of modifying the balance of the second electronic wallet (7000) by incorporating the balance data (559), wherein the subnetwork (405) modifies said balance of the second electronic wallet (7000) via the operating processes (558), and a P) step of unlinking with the subnetwork (405) the user identification data (101) of the electronic wallet (700) via the operating processes (558).

Thus, when the method finishes steps O) and P) the user (10) has as a new electronic wallet the second electronic wallet (7000) which now includes the data held by the electronic wallet (700) (e.g., tokens, cryptocurrencies, data of value, digital contract data), and the electronic wallet (700) is annulled and/or unlinked from the user identification data (101) identifying the user (10). Optionally, after completion of step P) no user (10) can access said electronic wallet (700).

On the other hand, the present disclosure also relates to a token transfer process (510) or data transfer process configured to enable transferring one or more data (e.g., tokens, cryptocurrencies, data of value, digital contract data) from an electronic wallet (700) to a destination electronic wallet (703).

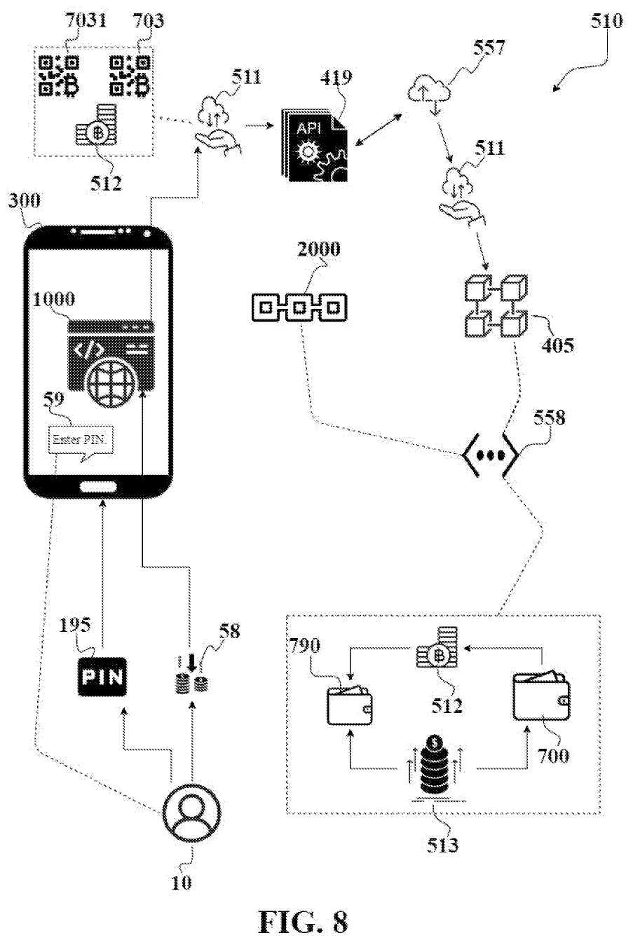

For example, referring to FIG. 8, the token transfer process (510) may include an R) step of displaying in the application (1000) a user password input message (59) and an S) step of receiving at the computing device (300) the user password (195).

Also, the token transfer process (510) may include a step T) of obtaining the private password data (701) by decrypting the encrypted private password (199) using the computing device (300); and a step U) of storing in the volatile memory module (310) the private password data (701). In steps T) and U) the token transfer process (510) enables the computing device (300) to access transactional functions of the electronic wallet (700) that enable sending data contained in the electronic wallet (700), particularly, data such as tokens and cryptocurrencies. For example, as long as private password data (701) is in the volatile memory module (310) the application (1000) can sign a transaction when the user (10) confirms that they want to make a token transfer.

The token transfer process (510) may include a step V) of obtaining a token transfer request (511) in the application (1000) via the computing device (300) when the user (10) enters a token transfer command (58) into said computing device (300), wherein the token transfer request (511) includes at least one wallet identification data (703) of the electronic wallet (700) of the user (10), a target wallet identification data (7031) of a target electronic wallet (790), and a token quantity data (512).

At this step, the user (10) interacts with the application (1000) through the computing device (300) to initiate a data transaction that will then be validated and/or recorded with the smart contract of the blockchain network (2000). For example, the token transfer command (58) may be generated when the user (10) interacts with one or more screens displayed by the application (1000) on the computing device (300), and the user (10) selects a button on the screen or enters a character string that the application (1000) may identify as a token transfer command (58).

The token transfer request (511) may be generated by the first computing module (1100) managing the application (1000) and, optionally, it may be generated by both the first computing module (1100) and the computing device (300).

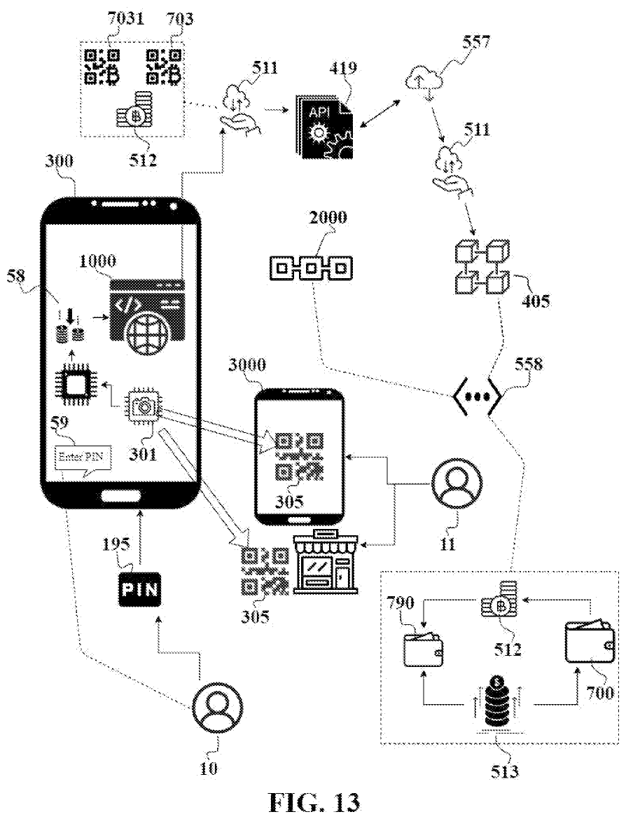

Referring to FIG. 13, in any embodiment the token transfer process (510) may include a step of reading with the computing device (300) an identification code (305) associated with a user (11) who owns or has access to the target electronic wallet (703). This step may be prior to step R).

In these embodiments, the computing device (300) may have an image acquisition device (301) that reads an identification code (305), e.g., a barcode or QR code, and based on the reading of the identification code (305), the computing device (300) proceeds to step R). When the user (10) enters the user password (195), and the computing device (300) receives it at step S), the computing device (300) can generate a transaction signature data which it then includes in the token transfer request (511).

Optionally, the identification code (305) may be received at the computing device (300) from another computing device (3000) accessed by the user (11) who has access to or owns the target electronic wallet (730). For example, the user (11) may send the identification code (305) from their computing device (3000) to the computing device (300) of the user (10) via a message (e.g., instant messaging, email, MMS, SMS, push messaging, related to the application (1100)).

Also, the identification code (305) may be a printed code, or a fixed code recorded as an image that may be found by the user (10) in a retail establishment, a web page, a social network, or any other type of physical or digital entity of the user (11). In this case, the user (10) reads the identification code (305) with the image acquisition device (301), the computing device (300) may generate a screen in which the user (10) selects one or more transaction details, e.g., the value of the token quantity data (512), or a product or service identification data that they want to purchase.

Additionally, the token transfer request (511) may be generated according to any other method of generating data transfer requests, e.g., methods of generating token and/or data transfers representing monetary value in transactional data networks, such as banking networks, payment networks, and blockchain networks, known to a person of ordinary skill in the art.

Referring to FIG. 8 and FIG. 13, in any embodiment of the token transfer process (510), a step X) of receiving the token transfer request (511) at the API (419) and a step W) of sending from the API (419) the token transfer request (511) to the subnetwork (405) configured to carry out the operational processes (558) of the blockchain network smart contract (2000), may be carried out.

In steps X) and W) the API (419) may translate the data contained in the token transfer request (511) into the language used by the blockchain network (2000). For example, the wallet identification data (703), the target wallet identification data (7031), and the token quantity data (512) may be received by the API (419) in a data exchange file (e.g., JSON) and translate one or more of such data into Solidity language.

Moreover, in method embodiments, the application (1000) may be configured to generate transaction signature data included within the token transfer request (511), and such transaction signature data may be in a format compatible with the language in which the blockchain network (2000) and its smart contract operates.

When the token transfer request (511) is sent to the subnetwork (405), the operating processes (558) of the smart contract may queue the token transfer to verify its validity. Then, one or more of the operational processes (558) verifies that the token transfer complies with some rules of the smart contract, e.g., that the electronic wallet (700) does have the tokens to be transferred, and the wallet identification data (703) and the destination wallet identification data (7031) are from existing and active electronic wallets in the blockchain network.

When one or more of the operating processes (558) verify that the token transfer complies with the smart contract rules, the method proceeds to a Y) step of carrying out the token transfer between the electronic wallet (700) and the target electronic wallet (703) on the blockchain network (2000) by carrying out at least one of the operating processes (558) of the smart contract.

In step Y) the token balances in the electronic wallet (700) and the target electronic wallet (703) are updated according to the number of tokens transferred.

Referring to FIG. 8 and FIG. 13, optionally, the token transfer process (510) further has a substep Y1) of obtaining via the subnetwork (405) a transfer record data (513) upon completion of the step Y), wherein the transfer record data (513) includes the wallet identification data (703) of the electronic wallet (700) of the user (10), the target wallet identification data (7031) of the target electronic wallet (790), and a number of tokens data (512) transferred, and wherein the transfer registration data (513) is recorded in the electronic wallet (700) and the target electronic wallet (790). The substep Y1) allows generating a receipt of the token transfer that allows keeping traceability of the transfer.

On the other hand, the present disclosure also relates to a token conversion process (515) enabling tokens of an electronic wallet (700) to be converted into data of value (521) that can represent money in a transactional network, such as a banking network.

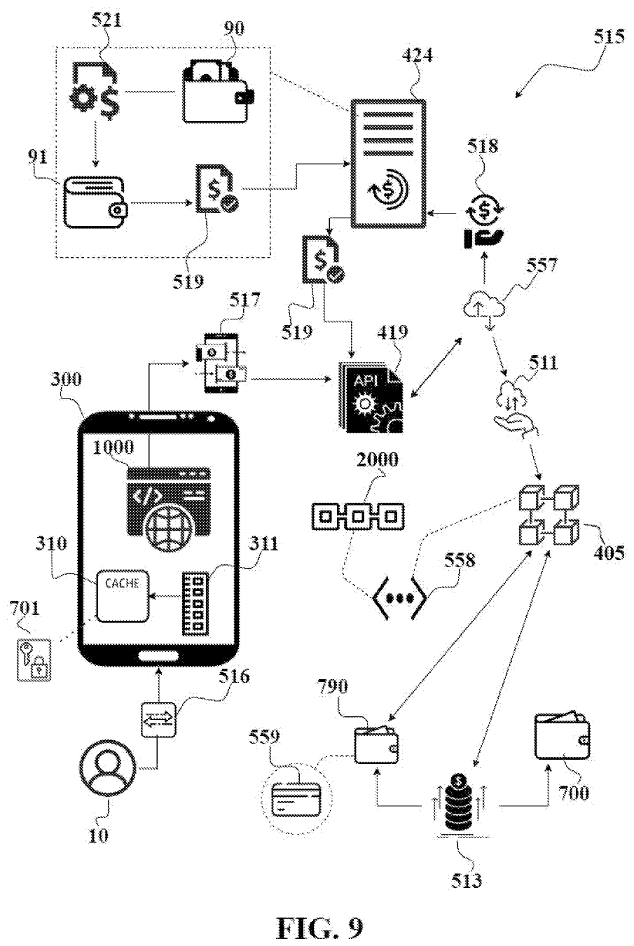

For example, referring to FIG. 9, the token conversion process (515) may include a Z1) step of receiving in the application (1000) a cash-closing command (516) entered by the user (10) into the computing device (300); and a step Z2) of moving to a step Z3) if the private password data (701) is stored in the volatile memory module (310), otherwise repeating steps R) to U) to store in the volatile memory module (310) the private password data (701).

In these embodiments of the token conversion process (515), it is sought to have the private password data (701) decrypted to be able to sign the tokenization transaction into data of value (521). On the other hand, the cash-closing command (516) may be a character string entered by the user (10) or may be generated from an interaction of the user (10) (e.g., selecting a button) with a screen displayed by the application (1000).

In step Z3), a cash-closing request (517) is sent from the application (1000) to the API (419). Preferably, the cash-closing request (517) includes a transaction signature data generated when the application (1000) detects that the private password data (701) is in the volatile memory module (310) of the computing device (300). The transaction signature data allows that when the cash-closing request (517) arrives at the API (419), the API (419) sends the cash-closing request (517) to the blockchain network (2000), and the operational processes (558) of the blockchain network (2000) take into account said transaction signature data for validation of transaction to convert tokens to data of value (521).

Then, the token conversion process (515) may carry out a Z4) step of querying the transfer record data (513) of the Y1) step in the subnetwork (405) via the API (419). Alternatively, the step Z4) may be replaced by a step of querying via the API (419) a balance data (559) of the electronic wallet (700) via a query process (560) taking as input the user identification data (101); wherein query process (560) is one of the operational processes (558). In any of these steps, the purpose is verifying that the electronic wallet (700) has the number of tokens to be converted into data of value (521). If it does, it proceeds to step Z5).

In step Z5) a transfer request (518) is sent to a fourth computing module (425) having at least one transactional module (424) and connecting to the API (419).

The transactional module (424) may be a physical or virtual server, an API, or any other computing module that allows receiving and transmitting, and/or processing requests for data transfers on a transactional network other than the blockchain network (2000).

Optionally, the API (419) and the transactional module (424) communicate via a communications protocol in which data may be transmitted in an encrypted manner, and/or credentials and certificates may be used to validate that data being transferred between the API (419) and the transactional module (424) has not been accessed, modified, or planted by another device (e.g., terminal, computing device, server).

In said transactional network the user (10) has a first account (90). Similarly, in said transactional network the user (11) may have a second account (91). For example, the first account (90) and the second account (91) may be savings accounts, checking accounts, credit card related accounts, revolving credit, and any other type of account configured to hold, receive and/or transfer data of value (521).

For example, the transactional module (424) may be part of a transactional network belonging to a banking institution. When the transactional module (424) receives the transfer request (518), the transactional module (424) may communicate with one or more servers, APIs, or computing modules of the transactional network to initiate the data of value transfer process (521). The one or more servers, APIs, or computing modules of the transactional network may be, or may belong to, a core bank.

A banking core can be a combination of hardware elements and computer-implemented methods configured to generate modules, applications, and network architectures with specific functions within the transactional network, such as account management, user database management, transaction verification and/or validation modules, request management modules, web services consumption modules, internal services, external services, and other modules that may intervene in the custody, transaction and validation of data of value transfers (521).

Returning to the token conversion process (515), it may include a step Z6) of obtaining a transfer verification data (519) when transferring data of value (521) between a first account (90) and a second account (91) accessed by the transactional module (424). The transfer verification data (519) may be generated by the transactional module (424), or by any other server, API, or computing device of the transactional network wherein the data of value (521) is transferred.

Any of the embodiments of the token conversion process (515) having at least steps Z1) and Z6) allows validating transactions between a first account (90) and a second account (91) without consuming a financial transaction service of a bank or credit/debit card franchise such as REDEBAN®, CREDIBANCO®, VISA®, MASTERCARD®, AMERICAN EXPRESS®, DINNERS®, DISCOVER®, INTERLINK®, STAR®, ACCEL®, INTERAC®, VISA READYLINK®, PULSE®, JCB®, and similar transaction service or payment networks known to a person of ordinary skill in the art. In contrast, the token conversion process (515) allows the use of the blockchain network (2000) as a transaction-validating entity.

Optionally, the token conversion process (515) has a step Z7) of receiving in the API (419) the transfer verification data (519); a step Z8) of sending from the API (419) to the subnetwork (405) the transfer verification data (519); and a step Z9) of modifying at the target electronic wallet (790) a balance data (559). Upon completion of the Z9) step, the transaction process that converts tokens to data of value (521) and leaves the electronic wallets (700, 703) with the correct token balance is completed.

Optionally, any of the embodiments of the above-described methods may further comprise a method of reloading electronic wallets (700) comprising a step of receiving in a wallet-management computing module a table data comprising a record having a first field in which the user identification data (101) of the user (10) is stored, a second field in which a wallet identification data (703) of an electronic wallet (700) of the user (10) is stored, and a third field with a data of tokens to be reloaded. The wallet-management computing module then carries out a step of sending a wallet reload request to the API (419), which communicates with the blockchain network (2000) to carry out a token deposit into the electronic wallet (700) according to the value of the token data to be reloaded. The wallet-management computing module may be accessed by an administrator user who authenticates to the wallet-management computing module the predetermined credentials or passwords.

Preferably, each time the token deposit is generated in the electronic wallet (700) according to the value of the token data to be reloaded, the wallet-management computing module permanently deletes the table data, thereby ensuring the confidentiality of token loading in the electronic wallet (700).

Moreover, the present disclosure also relates to a system configured to carry out one or more of the above-described method embodiments.

The system may include a first computing module (1100) configured to manage an application (1000) configured to establish connection with a user (10) computing device (300) via a communications network (1150), a second computing module (400) configured to manage a database (401), wherein the second computing module (400) is connected to the communications network (1150). Moreover, the system may include a third computing module (420) connected to the first computing module (1100), the second computing module (400), and the computing device (300) via the communications network (1150).

In some embodiments, the system may further include an identification server (415) connecting to one or more of the computing modules (1100, 400, 420) and/or the computing device (300) via the communications network (1150).

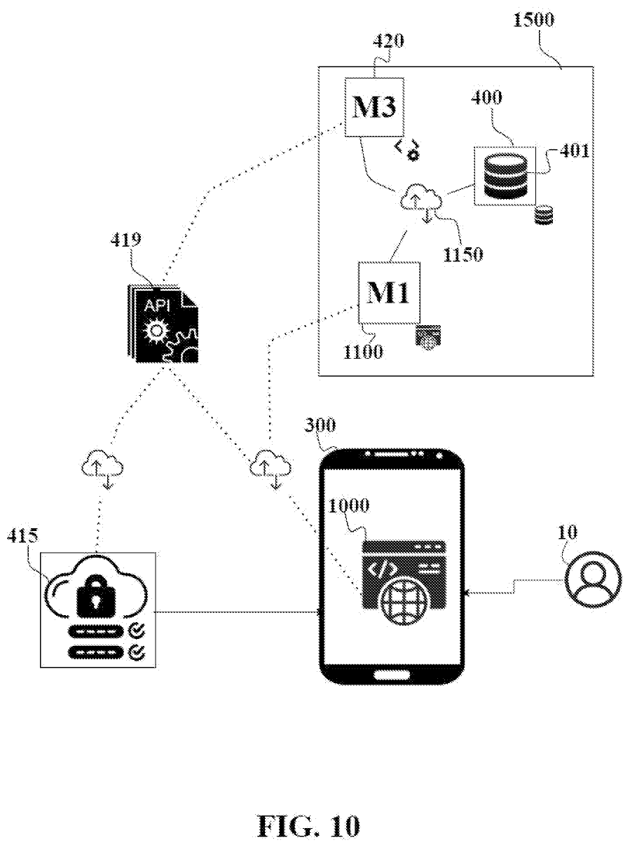

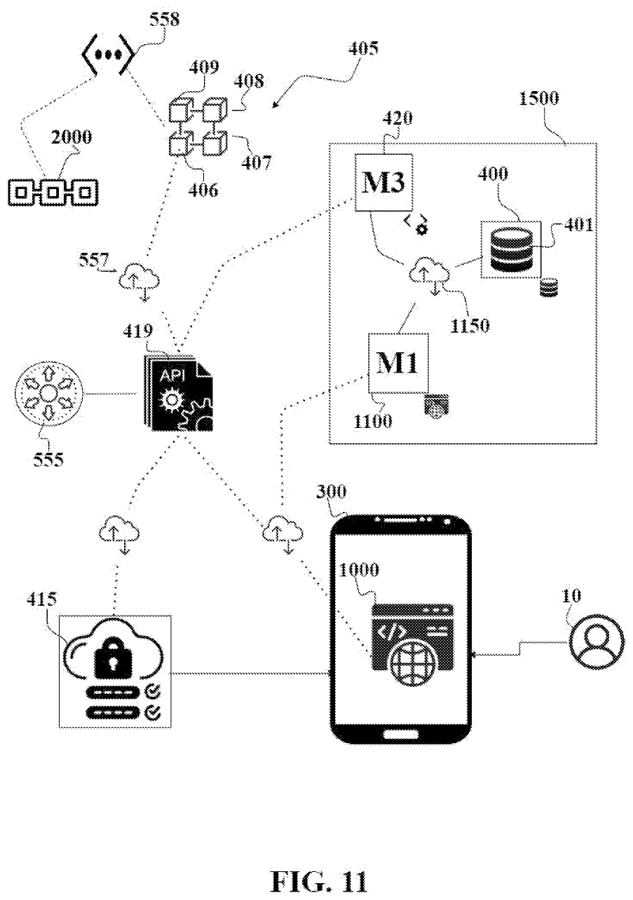

For example, referring to FIG. 10 and FIG. 11, the system may be, or may include a system for electronic wallet (700) creation and encryption system of a blockchain network (2000) configured to carry out any of the method embodiments for creating and encrypting an electronic wallet (700) of a blockchain network (2000).

Referring to FIG. 10, the electronic wallet creation and encryption system (700) of a blockchain network (2000) may include a first computing module (1100) configured to manage an application (1000). The application (1000) may be configured to establish connection with a user (10) computing device (300) via a communications network (1150), receiving from the computing device (300) a first character string (350) and a user password (195) which are entered by the user (10); and sending a first encrypted seed (750) from the application (1000) to an application programming interface API (419).

Also, the electronic wallet creation and encryption system (700) of a blockchain network (2000) may include a second computing module (400) configured to manage a database (401) configured to store a second encrypted seed (760), wherein the second computing module (400) is connected to the communications network (1150).

Moreover, the electronic wallet creation and encryption system (700) of a blockchain network (2000) may include a third computing module (420) connected to the first computing module (1100), the second computing module (400), and the computing device (300) via the communications network (1150) and configured to manage the API (419).

The API (419) may be configured to obtain the second encrypted seed (760) by carrying out a second encryption process (180) taking as input the first encrypted seed (750) and a second random salt (190); and establishing connection with the database (401). The API (419) can be developed in various languages and data types such as yaml which is a mix of JavaScript and XSL.

In turn, the computing device (300) may be configured to obtain the electronic wallet (700) through a process under BIP standard (150), wherein the electronic wallet (700) has a private password data (701), a public password data (702), and a wallet identification data (703). Moreover, the computing device (300) may be configured to obtain the first encrypted seed (750) through a first encryption process (160) taking as input the private password data (701), the public password data (702), the wallet identification data (703), the first character string (350), and a first random salt (170).

Similarly, the computing device (300) may be configured to obtain an encrypted private password (199) by a third encryption process (198) taking as input the user password (195) and the private password data (701); store the encrypted private password (199) in a memory module (311); and decrypt the encrypted private password (199) when a user enters into the application (1000) the user password (195), wherein upon decrypting the encrypted private password (199) the computing device (300) stores in a volatile memory module (310) the private password data (701).

In any embodiment of the system comprising a first computing module (1100) and a third computing module (420), the first computing module (1100) may be connected to the third computing module (420) via a communications protocol selected from HTTPS, HTTP, TCP/IP, SSH, REST, SOAP, and combinations thereof.

In any of the system embodiments in which a first computing module (1100) is included, the first computing module (1100) can be selected from a virtual machine, a server, a computer, a server farm, and combinations thereof.

In any embodiment of the system in which a second computing module (400) configured to manage a database (401) is included, the database (401) may be a non-relational database (e.g., MongoDB). One of the advantages of having as database (401) a non-relational database is that data of different types, languages, or categories (e.g., tables, data exchange files, images, videos, audio files) can be stored without the need to establish complex relational data structures.

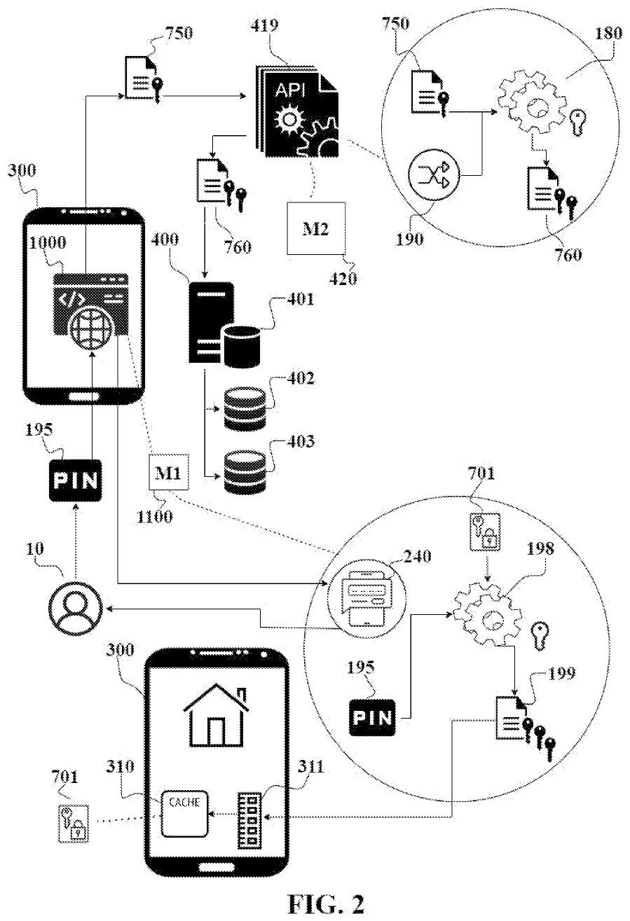

For example, referring to FIG. 1 and FIG. 2, in any of the system embodiments comprising a second computing module (400) configured to manage a database (401), the second computing module (401) may further access databases or data storage modules (402, 403) configured to store data related to profiles of users (10, 11) holding electronic wallets (700, 701) (e.g., photographs, demographic data, user identification data (101)) data related to businesses receiving as payment tokens sent from electronic wallets (700, 701), e.g., order registration data, shipped product or service data, invoice data, customer loyalty rewards data, transaction reporting data from token transaction reporting data transaction reporting data, among others.

In this disclosure, demographic data shall be understood as one or more data having information corresponding to, and inherent to, the characteristics of communities and human beings. This general information on groups of people usually includes attributes such as age, gender, city, socioeconomic stratum, place of residence, as well as social characteristics such as occupation, family status or income. In analytical processes, demographic data are used to provide a deeper insight into a population, study their behavior and find patterns.

Optionally the databases or data storage modules (402, 403) are part of a service architecture based on bucket applications or cloud data storage web services (e.g., Amazon S3, Firebase) with which the API (419) can communicate in a service-based communications protocol.

On the other hand, referring to FIG. 10 and FIG. 11, system embodiments carrying out method embodiments that include a step AA) preceding step A) of carrying out a user identity verification process, the system may further include an identification server (415) connected to the third computing module (420) and the first computing module (1100) via the communications network (1150).

Referring to FIG. 5, in these system embodiments the application (1000) may further be configured to receive a user identification data (101) entered by the user (10) into the computing device (300); send a request to the API (419); obtain an OTP input data (417) entered by the user via the computing device (300) after receiving an identification data (416); and send to the API (419) the OTP input data (417).

In turn, in said system embodiments the identification server (415) is configured to obtain the identification data (416) including an OTP key data after the API (419) receives the request; and send the identification data (416) to a user address selected from a phone number, email address, social network profile address, and combinations thereof.

Similarly, in such system embodiments the API (419) may further be configured to establish connection between the identification server (415) and the application (1000); and obtain an OTP validation data when the OTP input data (417) entered by the user (10) matches the OTP key data of the identification data (416).

Referring to FIG. 11, in any embodiment of the system, the system may further include a subnetwork (405) that establishes communication with the API (419) and is configured to carry out a plurality of operational processes (558) of a smart contract of the blockchain network (2000).

For example, the subnetwork (405) may include a plurality of nodes (406, 407, 408, 409) interconnected via a communications protocol selected from TCP and UDP, wherein each node (406, 407, 408, 409) is a computing device, computing module, terminal, or server, and wherein the nodes (406, 407, 408, 409) are configured to carry out a plurality of operational processes (558) of the blockchain network smart contract (2000).

Each node (406, 407, 408, 409) may establish communication with a blockchain transaction module (555) of the API (419) via a communications protocol selected from TCP, SSH, TCP/IP, HTTPS, and combinations thereof. Optionally, the nodes (406, 407, 408, 409) are part of a service-based network of nodes, such as those of Amazon Web Services, Azure, and similar services known to a person of ordinary skill in the art.

Referring to FIG. 10 and FIG. 11, in any embodiment of the system, said system may include a central computing unit (1500), which may contain the first computing module (1100), the second computing module (400), the third computing module (420). For example, the central computing unit (1500) may be a server, and the first computing module (1100), the second computing module (400), the third computing module (420), may be hardware elements of the server. Also, the first computing module (1100), the second computing module (400), the third computing module (420), may be logical structures of the central computing unit (1500), e.g., those using certain processing modules, memory modules, and communications modules of the central computing unit (1500).

For example, the central computing unit (1500) may have three processors, or a processor with three or more cores, and the central computing unit (1500) may be configured so that each processor or processor core is assigned to a different computing module (1100, 400, 420). Similarly, this partitioning or segmentation of the central computing unit (1500) may be applied to assign to a computing module (1100, 400, 420) different partitions and/or hardware elements of hard disk drive (HDD, SDD), RAM memory, ROM memory, and such other hardware elements as may be included in the central computing unit (1500).

In these system embodiments having a central computing unit (1500), first computing module (1100), second computing module (400), third computing module (420), each computing module (1100, 400, 420) may include a communications module having one or more connection ports configured to access a communications network (1150), e.g., a wired network, a wireless network, and combinations thereof. Examples of communications networks may be networks the Internet, VPN networks, LANs, WANs, other networks communications networks (1150) equivalent and the like known to a person of ordinary skill in the art, and combinations thereof.

Examples of wired communication modules have a wired connection port allowing communication with external devices via a communication bus, selected among others from the group consisting of I2C (IIC Inter-Integrated Circuit), CAN (Controller Area Network), Ethernet, SPI (Serial Peripheral Interface), SCI (Serial Communication Interface), QSPI (Quad Serial Peripheral Interface), SCI (Serial Communication Interface) and QSPI (Quad Serial Peripheral Interface), SPI (Serial Peripheral Interface), SCI (Serial Communication Interface), QSPI (Quad Serial Peripheral Interface), 1-Wire, D2B (Domestic Digital Bus), Profibus and others known to a person of ordinary skill in the art, and combinations thereof.

Examples of wireless communication modules use a wireless communication technology selected from the group consisting of Bluetooth, WiFi, Radio Frequency, Radio Frequency, and RFID. RFID (Radio Frequency Identification), UWB (Ultra-Wide Band), GPRS, Konnex or KNX, DMX (Digital MultipleX), WiMax and equivalent wireless communication technologies that are known to a person moderately knowledgeable in the field and combinations thereof.

In system embodiments which do not have a central computing unit (1500), or in which the central computing unit (1500) does not include all of the computing modules (1100, 400, 420) of the system, said system may comprise a plurality of modules, virtual cloud networks, virtual machines, servers, and computing units interconnected with each other by communications network (1150) in which one or more communications protocols may be established.

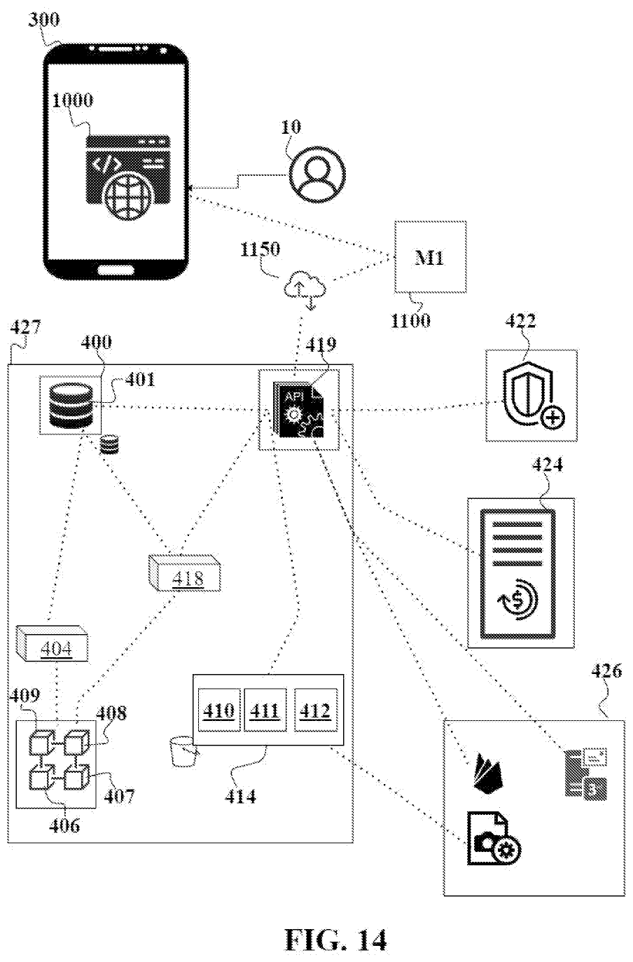

For example, referring to FIG. 14, in an embodiment of the system, said system includes a virtual cloud network (427) (e.g., an Amazon Virtual Private Cloud (Amazon VPC)). Preferably, the virtual cloud network (427) is a virtual private network.

The virtual network in the cloud (427) is a collection of hardware elements and virtual machines configured to logically provide a service. The virtual cloud network (427) can control all aspects of the virtual network environment, such as selecting a range of IP addresses, creating subnets, and configuring routing tables and network gateways. It may use both IPv4 and IPv6 for most virtual private cloud resources, helping to ensure a secure and easy access to resources and applications.

The virtual network in the cloud (427) makes it easy to customize the network configuration and allows creating one or more subnets with public access for web servers with Internet access. It also allows backend systems, such as application servers or databases, to be placed on a subnet with private access without Internet access. With the virtual cloud network (427), multiple layers of security, including security groups and network access control lists, can be used to help control access to instances of data processing modules (e.g., Amazon EC2) in each subnet.

Returning to FIG. 14, the virtual cloud network (427) may include the second computing module (400) and the third computing module (420). In turn, the first computing module (1100) may be on a different virtual cloud network, or on a physical server or virtual machine independent of the virtual cloud network (427). The virtual cloud network (427) communicates with the first computing module (1100) via API (419) managing the third computing module (420). The API (419) establishes communication with the application (1000) managing the first computing module (1100) via the communication network (1150), which may be the Internet.

The API (419) and the application (1000) may establish a service-based communications protocol, e.g., API-REST, API-WEB, REST, RESTful, or SOAP. The third computing module (420) optionally may be a public subnetwork of the virtual cloud network (427).

Optionally, the API (419) may consume services from one or more request processing modules (426) that may be selected from image data management modules, service-based data storage modules, message delivery outsourcing modules (e.g., email, SMS, MMS, instant messaging, etc.), and other service-based data storage modules (e.g., email, SMS, MMS, instant messaging, push messaging) and combinations thereof.

The virtual cloud network (427) may further include the subnetwork (405) of the blockchain network (2000) and may include a data storage module (414), which may be of a bucket type (e.g., Amazon Web Services-S3 bucket, Firebase). The data storage module (414) may include submodules (410, 411, 412), which are fractions, portions, or parts of the data storage module (414), in which different types of data are stored. For example, in a first submodule (410), backup data of one or more data produced and exchanged in any of the above-described method embodiments, may be stored. For example, the subnetwork (405) may be a private subnetwork (e.g., PANTHEON-based network).

The virtual cloud network (427) may be configured so that its modules communicate with each other using different communications protocols to avoid leaking information outside the virtual cloud network (427). For example, the API (419) may communicate with a second computing module (400) using an SSH and/or TCP communications protocol. Optionally, the virtual cloud network (427) may include a network monitoring module (418) (e.g., Bastion-Zabbix) configured to monitor the capacity, performance, and availability of modules, servers, equipment, applications, and databases of the virtual cloud network (427).

For example, the network monitoring module (418) may communicate with the API (419), the subnetwork (405), and the second computing module (400) via an SSH-TCP communications protocol. In turn, the nodes (406, 407, 408, 409) of the subnetwork (405) may communicate with each other using a UDP communications protocol. Optionally, one or more of the nodes (406, 407, 408, 409) of the subnetwork (405) may communicate with the second computing module (400) via a cloud router module (404) (e.g., Amazon Web Service Transit GateWay). In alternative system embodiments, the cloud router module (404) may be replaced by a hardware element configured to route data, e.g., a router.

On the other hand, the virtual cloud network (427) may be configured for the API (419) to connect to a transactional module (424) via a TCP and HTTPS-based communications protocol.

On the other hand, the present disclosure also describes a computer program comprising instructions, which when the program runs on a system, according to any of the above-described system embodiments, cause said system to carry out the steps of a method according to any of the method embodiments previously described in this disclosure.

The computer program may be divided into two or more files, protocols, computing models, and combinations thereof which are instantiable, executable and/or installable being configured to install and/or carry out, or instantiate instructions in the first computing module (1100), the second computing module (400), the third computing module (420), the computing device (300), and other hardware elements of any of the above-described system embodiments. Said installed, carried out or instantiated instructions generate that the hardware elements of the system can carry out the above-described method embodiments.

On the other hand, the present disclosure also describes a computer-readable medium comprising instructions, which when the program runs on a system according to any of the above-described embodiments, cause said system to carry out the steps of a method according to any of the method embodiments previously described in this disclosure.

The computer-readable medium may be selected from executable files, installable files, compact disks, RAM (cache memory, SRAM, DRAM, DDR), ROM memory (Flash, Cache, hard disks, SSD, EPROM, EEPROM, removable ROM memories (e.g. SD (miniSD, microSD, etc.), MMC (MultiMedia Card), Compact Flash, SMC (Smart Media Card), SDC (Secure Digital Card), MS (Memory Stick), among others), CD-ROM, Digital Versatile Disc (DVD) or other optical storage, magnetic cassettes, magnetic tapes, storage or any other media that can be used to store information and can be accessed by a processing unit.

The computer-readable medium may be a set of computer-readable elements into which instructions are divided or fractionated which when carried out by the first computing module (1100), the second computing module (400), the third computing module (420), the computing device (300), and other hardware elements of any of the above-described system embodiments, allow carrying out the steps, stages, substeps of a method according to any of the method embodiments previously described in this disclosure. The division or fractionation of the steps, stages, substeps enables the first computing module (1100), the second computing module (400), the third computing module (420), the computing device (300) and other hardware elements of any of the above-described system embodiments to read the instructions the computer-readable medium can specifically carry out the steps, stages, substeps thereof within a method, according to any of the method embodiments previously described in this disclosure.

### EXAMPLES

### Example 1: Method for Creating and Encrypting an Electronic Wallet (700) of a Blockchain Network (2000)

In this example the electronic wallet (700) is generated on a computing device (300) which is the smartphone of a user (10).

The application (1000) is installed on the computing device (300) and a library is installed to generate electronic wallets.

In this example the user (10) is a new user, so a user registration process is carried out in which the user (10) interacts with the application (1000) and supplies their user identification data (101), which in this case is their ID or passport number. This user identification data (101) is sent by the application (100) to the API (419) so that the API (419) sends it to the second computing module (400) to be stored in the database (401). In this example the second computing module (400) is a private subnet of MongoDB, and the database (401) is a non-relational database.

When the user (10) is registered, the user identity verification process is carried out to authenticate the user (10) by means of a One Time Password.

Returning to the creation of the electronic wallet (700), in this example the user interacts with the application (1000) to create the electronic wallet (700) in the computing device (300). The computing device (300) runs a library under the BIP 44 standard. The electronic wallet (700) has a private password data (701), a public password data (702) and a wallet identification data (703) (in this case it is a hexadecimal identifier compatible with RSK/Ethereum).

The electronic wallet (700) is generated by 12 random words coming out of a React Native library (React native 39) called inside the computing device (300) under the BIP 39 standard. The 12 words are taken as the seed that creates the private password data (701), the public password data (702), the wallet identification data (703).

In this example, before, during, or after the creation of the electronic wallet (700), the application (1000) displays a login message instructing the user (10) to enter a first character string (350) and a user password (195). The first character string (350) is a secret word of at least 8 characters and the user password (195) is a four-digit PIN.

Then, the method proceeds to obtain a first encrypted seed (750) through a first encryption process (160) carried out by the computing device (300) taking as input the private password data (701), the public password data (702), the wallet identification data (703), the first character string (350) and a first random salt (170).

Subsequently, in this example the method sends the first encrypted seed (750) from the application (1000) to the API (419). The API (419) is programmed in YAML language. Then the API (419) obtains a second encrypted seed (760) by carrying out a second encryption process (180) taking as input the first encrypted seed (750) and a second random salt (190). The API (419) sends the second encrypted seed (760) to the second computing module (400) for storage in the database (401).

Also, in the present example an encrypted private password (199) is obtained by a third encryption process (198) carried out by the computing device (300) taking as input the user password (195) and the private password data (701).

The first encryption process (160), the second encryption process (180) and the third encryption process (198) are AES 256 processes and the first random salt (170), and the second random salt (190) are 16 random complementary character words.

### Glossary

Electronic Wallet (700): In the present disclosure, electronic wallet is defined as a software application that, like a real wallet, is configured to store credit card information, banking information and, in particular, in most method embodiments described herein, the electronic wallet (700) is configured to store data that is exchanged on a blockchain network (2000) (e.g., tokens, cryptocurrencies, etc.). Moreover, the electronic wallet (700) may be configured to store shipping data (e.g., holder's residence address, city, zip code) and other personal data of the user (10).

Moreover, the electronic wallet (700) can store credentials and other security elements to authenticate the user (10) and/or the service provider. The electronic wallet (700) may act as browser plug-ins, making it possible for a credit card holder to carry out online banking and retail transactions, managing payment receipts, and storing digital certificates. In addition, the electronic wallet (700) can also store personal data (such as banking and health care data), corporate data (such as customer contact information, correspondence, etc.), and various security features for accessing personal and corporate networks and other resources or services.

The electronic wallet (700) may be comprised of at least one private password data (701), one public password data (702), and one wallet identification data (703), which may be obtained by a process under BIP standard (150), e.g., BIP standard 39.

The BIP39 standard is a method for generating private keys using a series of mnemonic words helping to support an electronic wallet (700) and at the same time guaranteeing the construction of the private password data (701) and the public password data (702) in a secure manner. The BIP-39 takes random words (usually from the English language, although they can be from another language) and creates with them a long sentence (usually between 12 to 24 words). Here, the higher the number of words, the higher the entropy and security attributable to the resulting sentence.

Blockchain Network (2000): In the present disclosure, electronic wallet (700) or blockchain network (2000) is defined as a network with the ability to include applications on its structure, such as smart contracts and distributed applications or DApps1. Smart contracts not only define the rules and penalties around an agreement in the same way as a traditional contract does, but also automatically enforce those obligations. They allow automating business mechanisms such as payments, agreements, and registrations paving the way for the implementation of Decentralized Autonomous Organizations (DAOs).

Generally, a blockchain network (2000) is a distributed chain of block data structures accessed by a network of nodes, e.g., the subnetwork (405) and its nodes (406, 407,408, 409) described in the present disclosure. Said network of nodes is often referred to as a network of miners. Each block in a blockchain includes one or more data structures and, in some exemplary blockchains, a Merkle tree of hash or digest values for transactions included in a block is used to obtain a hash value for a block, which in turn is combined with a hash value of a previous block to generate a blockchain. The blocks in the chain can be linked using hash pointers connecting the current block to the previous block and so on until a genesis block is reached.

Smart Contract: Smart contracts are pieces of software written in a particular language (e.g., Solidity) being part of the technology package of blockchains based on blockchain networks (e.g., Ethereum, RSK). This type of languages is oriented towards correctness and not optimization, as is usually the case with typical languages used for most conventional solutions. A smart contract allows programming conditions and generating an environment for the different “assets” to be represented.

For example, a smart contract may include a set of instructions, rules, and operating processes (558) which can be applied during one or more of the steps of any of the method embodiments described in this disclosure.

Optionally, a blockchain network (2000) may be configured to carry out or “enforce” a plurality of smart contracts. Each smart contract has an identifier and are correlated with each other. For example, the blockchain network (2000) may be configured for carrying out a smart contract manager, accessed via APIs (e.g., API (419)), which contains three other smart contracts managing the entire application. The first is the interface contract which is in charge of receiving data transactions, the second contract is in charge of all logic, and the third contract is in charge of data storage. This combination of contracts allows the system to carry out any of the methods disclosed herein to manage several processes in parallel and improve efficiencies. The functionalities of these contracts are distributed as follows:

Computing Device (300): In the present disclosure, computing device (300) is defined as an electronic device with hardware elements in which communication with one or more computing devices and/or servers can be established to exchange data, tags, and commands through a communications network. Examples of computing devices are smartphones, tablets, phablets, personal computers, microprocessors provided with Internet communication modules and user interfaces, or any element having a processing unit configured to receive instructions from the user through a Human Interface Device (HID) and a display device configured to display messages and information to the user. In addition, the computing device (300) or electronic processing device may include a memory module, a wired communications module, a wireless communications module, and other modules for recording, querying, obtaining, sending, and receiving data, commands, and tags.

Computing Unit, Processing Unit, or Processing Module: A computing unit, processing unit, or processing module is a device that processes data, e.g., microcontrollers, microprocessors DSCs (Digital Signal Controllers), FPGAs (Field Programmable Gate Arrays), CPLDs (Complex Programmable Logic Devices), ASICs (Application Specific Integrated Circuits), SoCs (System on Chip), PSoCs (Programmable System on Chip), computers, servers, tablets, cell phones, smartphones, signal generators and computing units, processing units or processing modules known to the person of ordinary skill in the art, and combinations thereof.

Human Interface Device (HID): In the present disclosure, a Human Interface Device (HID) is defined as any device capable of allowing a user to input data into the computing unit of the computing device (300). Examples of Human Interface Devices (HID) include, without limitation, keyboard, mouse, trackball, touchpad, pointing device, joystick, touch screen, microphones coupled to voice data recognition and generation modules, cameras and other image capture devices coupled to gesture recognition and generation modules, among other devices capable of enabling a user to input data into the computing unit of the computing device, and combinations thereof.

Display Device: A display device is any device that can be connected to a computing unit and display its output, it is selected among others from CRT (Cathode Ray Tube) monitor, flat panel display, LCD (Liquid Crystal Display) display, active matrix LCD display, passive matrix LCD display, LED displays, display projectors, TV (4KTV, HDTV, plasma TV, Smart TV), OLED (Organic Light Emitting Diode) displays, AMOLED (Active Matrix Organic Light Emitting Diode) displays, QD (Quantum Dot Display) displays, segment displays, among other devices capable of displaying data to a user, known to technical experts, and combinations thereof.

Memory Module: In the present disclosure, a memory module or memory record is defined as a hardware element including, but not limited to, RAM (cache memory, SRAM, DRAM, DDR), ROM (Flash, Cache, hard disk, SSD, EPROM, EEPROM, removable ROM (e.g., SD (miniSD, microSD, etc.), MMC (MultiMedia Card), Compact Flash, SMC (Smart Media Card), SDC (Secure Digital Card), MS (Memory Stick), etc.), among others. SD (miniSD, microSD, etc.), MMC (MultiMedia Card), Compact Flash, SMC (Smart Media Card), SDC (Secure Digital Card), MS (Memory Stick), among others), CD-ROM, Digital Versatile Disc (DVD) or other optical storage, magnetic cassettes, magnetic tapes, storage or any other media that can be used to store information and can be accessed by a computing unit, processing unit, or processing module. Memory modules generally include instructions, data structures, software modules. Examples of data structures are a text or spreadsheet, or a database.

Communications Module: In the present disclosure, communications module is defined as a hardware element coupled a computing unit, processing unit, or processing module of a computing device (300) or a server, which allows establishing communication between one or more computing devices (300) or servers to exchange data, commands and/or tags.

For example, the communications module may be selected from the group consisting of wired communications modules, wireless communications modules, and wired and wireless communications modules.

Data: In the present disclosure, data is defined as a symbolic representation that may be numerical, alphabetical, algorithmic, logical, and/or vectorial encoding information.

A data can have a structure or frame composed of blocks of characters or bits representing different types of information. Each block is made up of character strings, numbers, logical symbols, among others.

A data can also be formed only of bits (strings in binary language), be formed of characters formed one by one by a combination of bits, be formed of fields, records or tables formed of fields and records, or be formed of data interchange files (formats such as csv, json, xls, among others). In addition, a data can be a matrix of n rows by m columns. In turn, a data may contain several data.

For example, when data has a frame structure, the frame may have a block of identifying characters, generally known as a header, which contains information relating to a computing device or processor sending the data and may contain information relating to a computing device or processor receiving the data. Preferably, if the data is in a frame format, the frame contains blocks related to layers according to the OSI reference model.

Also, the frame may have a tail character block (or simply tail), which identifies a computing unit or server that is the end of the data, i.e., after that block there is no more information contained in the data previously identified by the computing unit or server with the header. In addition, the data has between the header block and the tail block one or more character blocks representing statistics, numbers, descriptors, words, letters, logical values (e.g. Boolean) and combinations thereof.

Database: A database is defined as a set of organized and interrelated data, and a set of programs that allow users to access and modify that data. In addition, a database can be a collection of information configured to facilitate recovery, modification, reorganization, and deletion of data.

Communication Network: In the present disclosure, a computer network or communications network is defined as a set of technical means allowing remote communication between autonomous equipment such as computer devices and servers. It usually involves transmitting data by electromagnetic waves through various media (air, vacuum, copper cable, optical fiber, etc.). Non-limiting examples of a communications network are the Internet, WAN, and LAN. It shall be understood that the method and system disclosed herein may employ any type of equivalent communications network known to a person of ordinary skill in the art.

Server: In the present disclosure, a server is defined as a device with a processing unit configured to carry out a series of instructions corresponding to stages or steps of methods, routines, or processes. The server may install and/or carry out a computer program that may be written in Java, Javascript, Perl, PHP and C++, #C, Python, SQL, Swift, Ruby, Delphi, Visual Basic, D, HTML, HTML5, CSS, and other programming languages known to a person of ordinary skill in the art.

In addition, the server has a communications module that allows connection to other servers or computing devices.

Additionally, servers may connect to each other and to other computing devices through web service architectures and communicate via communications protocols such as SOAP, REST, HTTP/HTML/TEXT, HMAC, HTTP/S, RPC, SP, and other communications protocols known to a person of ordinary skill in the art.

Similarly, the servers mentioned in the specification of the present disclosure may be interconnected through networks such as the Internet, VPN networks, LANs, WANs, other equivalent or similar networks known to a person of ordinary skill in the art, and combinations thereof. These same networks may connect one or more computing devices or terminals to one or more servers.

Some of the servers mentioned in the specification of the present disclosure may be virtual servers or web servers.

Any of the servers of the present disclosure may include a memory module configured to store instructions which being carried out by the server, cause a part, or all, of one or more steps of any of the methods disclosed herein to be carried out.

In some embodiments of the present disclosure, one or more servers may be physical servers or virtual servers with a backup architecture or clustered architecture in which one or more replacement servers are configured to ensure high availability.

User (10, 11) or Customer: In the present disclosure, user (10, 11) or customer is defined as an individual or legal entity, partnership, organization, or company holder of an electronic wallet (700). In particular, the user (10, 11) or customer authorizes transfers or transactions from their account (90, 91) with another user (11, 10) or business by using their computing device (300).

Account (90, 91): In the present disclosure, account or user (10, 11) account (90, 91) is defined as a data, node, array, table, record or data group recorded in a database, representing a bank account, virtual wallet, or banking network node wherein a user (10, 11) may receive or issue data, which in some method embodiments disclosed herein said issued or received data represents money, tangible goods or intangible goods.

Application (1000) or Mobile Application (APP): In the present disclosure, application, or mobile application (APP) is defined as a software component configured to be accessed by a computing device (300). For example, the mobile application (APP) may be a PWA, native APP, hybrid APP, web page, other equivalent types of applications known to a person of ordinary skill in the art, and combinations thereof.

Progressive Web Application (PWA): A PWA application is a web application that does not occupy memory space on the computing device (300) because its support is on a virtual server or cloud server and may work for all users regardless of the browser they use because it can be adapted to each type of browser. In addition, a PWA application may include features of mobile applications such as push notifications, GPS and may also download a shortcut that is installed on a user interface of a computing device (300), e.g., a screen, home window or application menu, without the need to download it from an app store. In addition, PWA applications can be updated automatically without adding load to the computing device (300).

Moreover, the PWA application can work without having an Internet connection thanks to a feature called Service Worker which allows carrying out actions within the application without the need for a stable connection since PWA applications can store information in memory cache as well as native applications do.

In addition, the application PWA application is secure because it uses security protocols for information management such as TLS (Transport Layer Security). Additionally, the PWA application can be shared by URL through text messages, and it is very user-friendly since its design and experience is similar to that of a native application. Also, PWA applications may include responsive design, which means that they can run on any mobile device with any screen resolution.

Encryption Process: In the present disclosure, encryption process is defined as a process for encrypting (also called ciphering) an input data into an output data that does not allow the content of the input data to be identified. Encryption is the process of transforming data (plain text) into an incomprehensible or hidden form (cipher text) using an encryption key (often called a random salt). Decryption is the reverse process of encryption.

Examples of encryption processes with AES processes. There are currently three types of AES encryption: 128-bit, 192-bit, and 256-bit, where the latter is the most secure. This was designed based on Moore's Law, as early tests showed that in a relatively short time the power of processors could break the weakest cipher in decreasing periods of time.

Application Programming Interface API (419) or API (419): In the present disclosure, API (419) is defined as a software application configured to allow its products and services to communicate with others, without the need to know how they are implemented. For example, API (419) may be a set of one or more computer-readable instructions providing access to one or more sets of computer-readable instructions defining functions and/or data types, so that such functions and/or data types may be configured to run on a computer, computing module, server, or computing device along with an application program.

Volatile Memory Module (310): In the present disclosure, a volatile memory module (310) is defined as a hardware device configured as a storage medium that is generally structured as a series of arrays (or banks). Each bank is further organized as an array of “memory cells” in rows and columns, and each column is further divided by the input/output (I/O) width of the memory. Locations within memory are uniquely specified by bank, row, and column. A memory controller can be used to retrieve data from memory by indicating the location of the bank, row, and column of data. The volatile memory module (310) allows writing and reading the information stored in it. It is called “volatile” because if it is disconnected from electrical power, the information is lost. For this reason, this type of temporary memory is often used to store intermediate results or non-permanent data. An example of a volatile memory module (310) is a cache memory.

Identification Server (415): In the present disclosure, identification server (415) is defined as a server configured to manage a web service for generating and authenticating temporary one-time passwords or also called OTP (One Time Password). In various system embodiments and method of the present disclosure, the identification server (415) connects to the API (419) via a web services architecture through a communications protocol, such as REST, SOAP, HTTP, HTTP/S, among others.

User Identification Data (101): In the present disclosure, user identification data (101) is defined as data containing a numerical or categorical variable enabling identification of a user (10, 11). In some system embodiments and method of the present disclosure, the user identification data (101) includes at least one piece of data selected from the user's name, personal identification number (e.g., citizenship card, ID), social security, current residence address, or any other distinguishing data to ensure that the user identification data is associated with the user (10).

Wallet Recovery Command (51): In the present disclosure, wallet recovery command (51) is defined as an instruction that can be entered or generated in the computing device (300) to carry out a call through the API (419) (e.g., through an interface implemented in the application (1000)) that allows initiating the wallet recovery process.

Wallet Recovery Request (52): In the present disclosure, wallet recovery request (52) is defined as a data that generates a call (e.g., HTTPS call) to the API method (419) to initiate the wallet recovery process. For example, the wallet recovery request (52) may be generated by the application (1000) and/or by the computing device (300) in response to the wallet recovery command input (51). Alternatively, the wallet recovery command (51), along with the user identification data (101) may be sent directly to the API (419) and the API (419) may subsequently generate the wallet recovery request (52).

Character String Input Message (53): In the present disclosure, character string input message (53) is defined as an action or instance of the application (1000) wherein a graphical, auditory, audiovisual, box, fillable field, or interaction element is displayed on a human interface device (HID) and/or display device of the computing device (300), which prompts the user (10) to enter the first character string (350).

Blockchain Transaction Module (555): In the present disclosure, blockchain transaction module (555) is defined as one or more methods of the API (419) or associated with the API (419) that allow recording and/or carrying out transactions within the Blockchain network (2000).

Token Recovery Method (556): This method can be used to recover tokens held by an electronic wallet (700), e.g., when a user (10) wants to restore their electronic wallet (700) due to forgotten password (e.g., first character string (350), user password (195)). The token recovery method (556) may be initiated or may be part of a smart contract function of the blockchain network (2000).

Account Recovery Command (55): In the present disclosure, account recovery command (55) is defined as a command that is generated and/or entered into the computing device (300) when a user (10) wishes to reset their user password (195) due to a forgotten password or wish to change it and sends the reset instruction through the application (1000). This command can be carried out by a function of the smart contract causing the recovery of the user's (10) balance, creating a new electronic wallet (7000) and a new password key (e.g., first character string (350), user password (195)).

Account Recovery Request (56): It can be requested when the user (10) forgets their password (e.g., first character string (350)) and selects reset password in the application (1000), in order to retrieve their available tokens (556) and password.

Balance Data (559): In the present disclosure, balance data (559) is defined as a data containing a value of a variable that is associated with a data of value. For example, the data of value may be money and the balance data (559) may represent a monetary balance equal to or proportional to an amount of money. Alternatively, the balance data (559) may contain a numeric value of a numeric variable representing a number of tokens. Optionally, the tokens may have a monetary value equal to, or proportional to, an amount of money. For example, the balance data (559) may represent the monetary value in pesos (COP) contained in a given electronic wallet (700, 7000). (In this system the equivalence between pesos and tokens is 1:1.) Similarly, the balance data (559) may represent the monetary value in pesos (COP) contained in a given electronic wallet (700, 7000). Similarly, the balance data (559) may contain the value of a variable representing a quantity of units and/or fractions of cryptocurrencies (e.g., bitcoins, davipoints, Ethereum, Ripple XRP, Litecoin, NEO, IOTA, Tether, Cardano, Polkadot, Uniswap, and any other cryptocurrency or cryptocurrency known to a person of ordinary skill in the art).

Query Process (560): This process can be used at the time a token verification (512) is requested, wherein the value of a variable contained in the balance data (559) is verified (e.g., token balance) to carry out any token transfer (511).

Token Transfer Process (510): In the present disclosure, token transfer process (510) is defined as a computing process configured to enable, carry out, verify and/or record the exchange of tokens between a source electronic wallet (700) and a destination electronic wallet (790).

Token Transfer Request (511): In the present disclosure, token transfer request (511) is defined as a data sent to the API (419), or generated by the API (419) (e.g., an HTTPS call to the API (419)) configured to initiate the token transfer process (510) in order to carry out the exchange of tokens between a source electronic wallet (700) and a destination electronic wallet (790).

Token Quantity Data (512): In the present disclosure, token quantity data (512) is defined as a data containing a value of a numeric variable representing a quantity of tokens, e.g., a quantity of tokens stored in an electronic wallet (700) or sent from a source electronic wallet (700) and a destination electronic wallet (790). In some method embodiments, the application (1000) has one or more screens that include a graphical element on which the value of the token quantity data (512) can be displayed so as to be clearly identified by the user (10), thereby reducing steps in the application (1000) in which the user (10) interacts with the computing device (300) frequently to query the value of the token quantity data (512), e.g., each time the user (10) wants to make a token transfer.

Transfer Log Data (513): In the present disclosure, transfer record data (513) is defined as a data recording a movement of the electronic wallet (700, 7000). The transfer record data (513) may contain values of one or more numeric variables, categorical variables, or combinations thereof, wherein it is identified by a unique code (e.g., numeric, or alphanumeric character string) which is used in the blockchain to record and store a transaction. In a non-limiting example, the transfer record data (513) may be a Hash code as used in some blockchains known to a person of ordinary skill in the art.

Transferred Token Quantity Data (514): In the present disclosure, token quantity data (512) is defined as a data containing a value of a numeric variable representing a quantity of tokens transferred from an electronic wallet (700). This value may be included in the transfer record data (513), e.g., in order to evidence the value used to pay an amount for a good or service.

Token Conversion Process (515): In the present disclosure, token conversion process (515), or cash-closing process, is defined as a computing process configured to transform tokens of an electronic wallet (700) into data of value (521). For example, upon execution of the token conversion process (515), a user (10) of a business owning the electronic wallet (700) may redeem their tokens for data of value (521) representing money, whereupon, they may receive in an account (90, 91) (e.g., savings account, checking account, credit card account) a money transfer equivalent and/or proportional to the tokens converted during the token conversion process (515). In a non-limiting example, 1 token is equal to 1 unit of currency (e.g., Colombian peso, US dollar, euro, yen, etc.).

Cash-closing Command (516): In the present disclosure, a cash-closing command (516) means a data or instruction entered into the computing device (300) by a user (10), or a user authorized by the user (10), to send the tokens to the bank account (90, 91) registered by the owner of the business (user (10) holder of the electronic wallet (700, 7000). When the computing device (300) receives and/or generates the cash-closing command (516) the token conversion process (515) can be started.

Cash-closing Request (517): In the present disclosure, a cash-closing request (517) is defined as data generated by or sent to the API (419) when the cash-closing command (516) is entered and/or generated (e.g., HTTPS call to a method of the API (419)) in the computing device (300). The cash-closing request (517) may be sent by the user (10) who is manager of a business after having approved with their code the request of this owner.

Transfer Request (518): In the present disclosure, transfer request (518) is defined as a data sent to, or generated by the API (419) (e.g., HTTPS call to a method of the API (419)) wherein a transfer request is made where there is a user associated to a first account (90) or source account and a user associated to a second account (91) or destination account, where tokens are to be sent.

Fourth Computing Module (425): This is the module in charge of receiving and storing transactions.

Data of Value (521): In the present disclosure, data of value (521) is defined as a data or data structure containing variables that represent items having value in the real world. For example, data of value (521) may include a numeric variable whose value represents an amount of money. Additionally, the data of value (521) may include a categorical variable representing an access code necessary for another process in which there is a transaction of items, currencies, services, or information representing a value in the real world. For example, said access code may be an entry in a smart contract process to verify that the user (10) authorizes, accepts, grants, sends, trades, or exchanges something determined in the smart contract rules. Moreover, the data of value (521) may include sensitive information of the user (10) that may be used for different procedures, and this data is preferably protected.

User Password Entry Message (59): This is a message displayed by the application (1000) requesting the user (10) to enter the user password (195) (e.g., 8-digit alphanumeric character string, 4-digit pin, among others) in their computing device (300). This message may be displayed when the user (10) creates or opens their profile on a different computing device (300), or when the user (10) wishes to initiate or continue a token transfer process (510).

Token Transfer Command (58): In the present disclosure, token transfer command (58) is defined as a data entered by the user (10) into the computing device (300), or automatically generated by the computing device (300) and/or the application (1000) representing an instruction from the user authorizing the initiation of the token transfer process (510). This may also be interpreted as part of a process of signing a transaction. For example, the token transfer command (58) may be automatically generated by the computing device (300) and/or the application (1000) at the time the user (10) enters the user password (195) (e.g., 4-digit pin) to confirm a token transaction.

Command: In the present disclosure, “command” is defined as a data that can be manually entered by the user (10) into the computing device (300) (e.g., be a string of characters entered by the user (10)), or can be generated when the user (10) interacts with a screen, user interface of the application (1000), e.g., by pressing a button, selecting an option within a list of predetermined commands, entering an authentication data (e.g., identification data, data generated by biometric elements such as fingerprint reader, facial recognition modules, voice recognition modules, among others), and combinations of the foregoing actions, identification data, data generated by biometric elements such as fingerprint reader, facial recognition modules, voice recognition modules, among others) and combinations thereof actions. Examples of commands are the account recovery command (55), token transfer command (58), cash-closing command (516), and wallet recovery command (51).

The present disclosure is not limited to the described and depicted embodiments, since as will be evident to a person skilled in the art, there are possible variations and modifications which do not depart from the spirit of the invention that alone is defined by the following claims.

1. A method for creating and encrypting an electronic wallet (700) of a blockchain network (2000), comprising:
A) obtaining the electronic wallet (700) by a computing device (300) from a user (10);
wherein the electronic wallet (700) is obtained through a process under BIP standard (150) carried out by the computing device (300), and
wherein the electronic wallet (700) has a private password data (701), a public password data (702), and a wallet identification data (703);
B) receiving in an application (1000) accessed by the computing device (300) a first string of characters (350) and a user password (195) which are entered by the user (10) into the computing device (300)
wherein the application (1000) is managed by a first computing module (1100) that establishes connection with the computing device (300) through a communications network (1150);
C) obtaining a first encrypted seed (750) through a first encryption process (160) carried out by the computing device (300) taking as input the private password data (701), the public password data (702), the wallet identification data (703), the first character string (350) and a first random salt (170);
D) sending the first encrypted seed (750) from the application (1000) to an application programming interface API (419), wherein the API (419) is managed by a third computing module (420) connected to the first computing module (1100) and the computing device (300) via the communications network (1150);
E) obtaining with the API (419) a second encrypted seed (760) by carrying out a second encryption process (180) taking as input the first encrypted seed (750) and a second random salt (190);
F) storing the second encrypted seed (760) in a database (401) accessed by the API (419), where the database (401) is managed by a second computing module (400) which is connected to the third computing module (420) via the communications network (1150);
G) obtaining an encrypted private password (199) by a third encryption process (198) carried out by the computing device (300) taking as input the user password (195) and the private password data (701); and
H) storing the encrypted private password (199) in a memory module (311) of the computing device (300),
wherein the computing device (300) is configured to decrypt the encrypted private password (199) when a user enters into the application (1000) the user password (195), wherein upon decryption of the encrypted private password (199) the computing device (300) stores in a volatile memory module (310) the private password data (701).

2. The method of claim 1, wherein the first encryption process (160), the second encryption process (180), and the third encryption process (198) are selected from AES, AES 256, AES 132, Blowfish, DES, Serpent, Twofish processes, and combinations thereof.

3. The method according to any of the preceding claims, further comprising a step AA) preceding the step A) of carrying out a user identity verification process comprising the sub step s:
AA1) receiving in the application (1000) a user identification data (101) entered by the user (10) into the computing device (300);
AA2) sending from the application (1000) an OTP request (501) to the API (419), wherein the OTP request (501) includes the user identification data (101);
AA3) obtaining via an identification server (415) an identification data (416) including an OTP key data (502) after the API (419) receives the OTP request (501);
AA4) sending via the identification server (415) the identification data (416) to a user address selected from a telephone number, email address, social network profile address, and combinations thereof;
AA5) obtaining in the application (1000) an OTP input data (417) entered by the user via the computing device (300) after receiving the identification data (416);
AA6) sending from the application (1000) to the API (419) the OTP input data (417); and
AA7) obtaining via API (419) an OTP validation data (503) when the OTP input data (417) matches the OTP key data (502) and proceed to step A), otherwise repeat substep AA1).

4. The method according to any of the preceding claims, wherein the first character string (350) is a secret word.

5. The method according to any of the preceding claims, wherein the user password (195) is a number.

6. The method according to claim 1, further comprising a wallet recovery process comprising the steps:
i) receiving in the application (1000) a wallet recovery command (51) entered by the user (10) through the computing device (300);
ii) sending from the application (1000) to the API (419) a wallet recovery request (52), wherein the wallet recovery request (52) includes a user identification data (101);
iii) extracting the second encrypted seed (760) from the database (401) through the API (419), wherein the API (419) queries the database (401) taking as input the user identification data (101);
iv) obtaining the first encrypted seed (750) in the API (419) by decrypting the second encrypted seed (760);
v) receiving in the application (1000) the first encrypted seed (750) from the API (419);
vi) displaying a character string input message (53) in the application (1000);
vii) receiving in the application (1000) the first character string (350) when the user (10) enters said first character string (350) into the computing device (300);
viii) decrypting in the computing device (300) the first encrypted seed (750) to obtain the private password data (701);
ix) receiving in the computing device (300) a user password (195) entered by the user (10), and
x) carrying out steps G) to H).

7. The method according to any of the preceding claims, further comprising a wallet transaction access process, comprising:
I) receiving in the application (1000) the user password (195) entered by the user (10) into the computing device (300);
II) decrypting with the computing device (300) the encrypted private password (199), wherein the computing device (300) stores the private password data (701) in a volatile memory module (310), and
III) establishing communication between the application (1000) and a blockchain transaction module (555) of the API (419);
where at the end of step III) the electronic wallet (700) is enabled to make transactions in the blockchain network (2000) through the interaction of the user (10) with the application (1000) by means of the computing device (300).

8. The method according to any of the preceding claims, further comprising a token recovery method (556) comprising:
J) receiving in the application (1000) an account recovery command (55) entered by the user (10) into the computing device (10);
K) sending an account recovery request (56) from the application (1000) to the API (419); wherein the account recovery request (56) includes a user identification data (101) of the user (10);
L) repeating steps A) to H) to obtain a second electronic wallet (7000);
M) establishing connection between the API (419) and the blockchain network (2000) through a communications protocol (557) that allows connecting to a subnetwork (405) configured to carry out some operational processes (558) of the smart contract of the blockchain network (2000);
N) obtaining with the subnetwork (405) a balance data (559) of the electronic wallet (700) by means of a query process (560) taking as input the user identification data (101); wherein the query process (560) is one of the operating processes (558);
O) modifying the balance of the second electronic wallet (7000) by incorporating the balance data (559), wherein the subnetwork (405) modifies said balance of the second electronic wallet (7000) using the operational processes (558); and
P) unlinking with the subnetwork (405) the user identification data (101) of the electronic wallet (700) by means of the operational processes (558).

9. The method according to any of the preceding claims, further comprising a token transfer process (510) comprising:
R) displaying in the application (1000) a user password entry message (59);
S) receiving on the computing device (300) the user password (195);
T) obtaining the private password data (701) by decrypting the encrypted private password (199) by means of the computing device (300);
U) storing in the volatile memory module (310) the private password data (701);
V) obtaining a token transfer request (511) in the application (1000) via the computing device (300) when the user (10) enters a token transfer command (58) in said computing device (300), wherein the token transfer request (511) includes at least one wallet identification data (703) of the electronic wallet (700) of the user (10), a target wallet identification data (7031) of a target electronic wallet (790), and a token quantity data (512);
W) receiving the token transfer request (511) in the API (419);
X) sending from the API (419) the token transfer request (511) towards a subnetwork (405) configured to carry out some operational processes (558) of a smart contract of the blockchain network (2000);
Y) carrying out the token transfer between the electronic wallet (700) and the target electronic wallet (703) in the blockchain network (2000) by carrying out at least one of the operating processes (558) of the smart contract.

10. The method according to claim 9, further comprising:
Y1) obtaining through the subnetwork (405) a transfer register data (513) at the end of step Y),
where the transfer record data (513) includes the wallet identification data (703) of the electronic wallet (700) of the user (10), the destination wallet identification data (7031) of the destination electronic wallet (790) and a number of tokens data (512) transferred, and
where the transfer registration data (513) is registered in the electronic wallet (700) and in the destination electronic wallet (790).

11. The method according to claim 10, further comprising a token conversion process (515) comprising:
Z1) receiving in the application (1000) a cash-closing command (516) entered by the user (10) into the computing device (300);
Z2) proceeding to step Z3) if the private password data (701) is stored in the volatile memory module (310), otherwise, repeating steps R) to U) to store in the volatile memory module (310) the private password data (701);
Z3) sending a cash-closing request (517) from the application (1000) to the API (419);
Z4) querying the transfer record data (513) of step Y1) in subnetwork (405) via API (419);
Z5) sending a transfer request (518) to a fourth computing module (425) having at least one transactional module (424) and connecting to the API (419), and
Z6) obtaining a transfer verification data (519) when transferring data of value (521) between a first account (90) and a second account (91) accessed by the transactional module (424).

12. The method of claim 11, further comprising:
Z7) receiving in the API (419) the transfer verification data (519);
Z8) sending from the API (419) to the subnetwork (405) the transfer verification data (519); and
Z9) modifying in the target electronic wallet (790) a balance data (559).

13. An electronic wallet creation and encryption system (700) of a blockchain network (2000), comprising:
a first computing module (1100) configured to manage an application (1000), wherein the application (1000) is configured to:
establish a connection to a user (10) computing device (300) through
receiving from the computing device (300) a first string of characters (350) and a user password (195) that are entered by the user (10); and
sending a first encrypted seed (750) from the application (1000) to an application programming interface API (419);
a second computing module (400) configured to manage a database (401) configured to store a second encrypted seed (760), wherein the second computing module (400) is connected to the communications network (1150);
a third computing module (420) connected to the first computing module (1100), the second computing module (400), and the computing device (300) via the communications network (1150), and configured to manage the API (419), wherein the API (419) is configured to:
obtaining the second encrypted seed (760) by carrying out a second encryption process (180) taking as input the first encrypted seed (750) and a second random salt (190); and
establishing connection with the database (401), and
wherein the computing device (300) is configured to:
obtaining the electronic wallet (700) through a process under BIP standard (150), wherein the electronic wallet (700) has a private password data (701), a public password data (702), and a wallet identification data (703);
obtaining the first encrypted seed (750) through a first encryption process (160) taking as input the private password data (701), the public password data (702), the wallet identification data (703), the first character string (350), and a first random salt (170);
obtaining an encrypted private password (199) by a third encryption process (198) taking as input the user password (195) and the private password data (701);
storing the encrypted private password (199) in a memory module (311); and
decrypting the encrypted private password (199) when a user enters into the application (1000) the user password (195), wherein upon decryption of the encrypted private password (199) the computing device (300) stores in a volatile memory module (310) the private password data (701).

14. The system of claim 13, wherein the first computing module (1100) is connected to the third computing module (420) via a communications protocol selected from HTTPS, HTTP, TCP/IP, SSH, REST, SOAP, and combinations thereof.

15. The system according to any of claims 13 and 14, further comprising an identification server (415) connected to the third computing module (420) and the first computing module (1100) via the communications network (1150),
where the application (1000) is also configured for:
receiving a user identification data (101) entered by the user (10) into the computing device (300);
sending a request to the API (419);
obtaining an OTP input data (417) entered by the user via the computing device (300) after receiving an identification data (416);
sending to the API (419) the OTP input data (417);
where the identification server (415) is configured for:
getting the identification data (416) that includes an OTP key data after the API (419) receives the request; and
sending the identification data (416) to a user address selected from a telephone number, e-mail address, social network profile address, and combinations thereof; and
where API (419) is also configured for:
establishing connection between the identification server (415) and the application (1000); and
obtaining an OTP validation data when OTP input data (417) entered by the user (10) matches the OTP key data of the identification data (416).

16. The system according to any of claims 13 to 15, wherein the first computing module (1100) is selected from a virtual machine, a server, a computer, a server farm, and combinations thereof.

17. The system according to any of claims 13 to 16 wherein the database (401) is a non-relational database.

18. The system according to any of claims 13 to 17, further comprising a subnetwork (405) establishing communication with the API (419), wherein the subnetwork (405) includes a plurality of nodes (406, 407, 408, 409) interconnected via a communications protocol selected from TCP and UDP,
where each node (406, 407, 408, 409) is a computing device, and
wherein the nodes (406, 407, 408, 409) are configured to carry out a plurality of operational processes (558) of a smart contract of the blockchain network (2000).

19. The system according to claim 18, wherein each node (406, 407, 408, 409) establishes communication with a blockchain transaction module (555) of the API (419) via a communications protocol selected from TCP, SSH, TCP/IP, HTTPS, and combinations thereof.
